(19) United States
(12) Patent Application Publication
(10) Pub. No.: US 2026/0290182 A1
(43) Pub. Date: Sep. 24, 2026

(54) COMBINATION LEARNING MANAGEMENT AND GAMING SYSTEM AND METHOD

(71) Applicant: ZYGRLE LLC, Ferndale, MI (US)

(72) Inventor: Cameron Roper, New Haven, MI (US)

(21) Appl. No.: 19/575,187

(22) Filed: Mar. 23, 2026

Related U.S. Application Data
(60) Provisional application No. 63/776,505, filed on Mar. 24, 2025.

(51) Int. Cl. G09B 5/02; G06N 3/0475

(52) U.S. Cl. CPC G09B 5/02; G06N 3/0475

(57) ABSTRACT

Ways for implementing curriculum-based educational activities for a student within an interactive gaming environment are provided that include receiving educational data via a management module and providing the educational data to an education platform. The educational data is provided to the student via a dashboard and to an analytics module. The analytics module correlates the educational data to a placement, including a mastery level, a learning gap, and a readiness level for advanced content. An artificial intelligence (AI) agent generates placement content from the placement for incorporation in a game-instance. A content generation module generates the game-instance within an experience platform based on the placement content via the AI agent. The experience platform generates an experience within the interactive gaming environment, where the experience includes the game-instance and the placement content.

### CROSS-REFERENCE TO RELATED APPLICATIONS

This application claims the benefit of U.S. Provisional Application No. 63/776,505, filed on Mar. 24, 2025. The entire disclosure of the above application is incorporated herein by reference.

### FIELD

The present technology relates to educational technology, specifically integrating educational methodologies with interactive gaming environments.

### INTRODUCTION

This section provides background information related to the present disclosure which is not necessarily prior art.

Educational technology platforms may face challenges in engaging learners effectively through interactive and immersive experiences. Certain digital learning environments may rely on static content delivery methods such as video lectures, text-based assignments, and quizzes that may fail to captivate students and foster genuine interest in learning. This lack of engagement may be compounded by the digital transformation of the education sector, where many platforms may still depend on passive content models. For example, educational systems may remain fragmented across school-managed learning management system environments, direct-to-consumer learning tools, and gaming ecosystems, creating disconnected experiences for learners. As a result, student motivation and retention rates may be limited, presenting difficulties for educators in cultivating desired learning outcomes and maintaining consistent student participation across diverse subject areas.

Certain learning management platforms may provide assignment and grading functionalities but may largely depend on passive learning models that do not incorporate dynamic or interactive elements in a comprehensive manner. Platforms such as Google Classroom™, Blackboard™, and Canvas^{®}, may offer organizational tools for educators and students but may lack immersive engagement features. While certain game-based learning platforms may offer interactive opportunities through quizzes and live interaction, integration of these elements with substantive curriculum content may remain limited in customization and depth. Standalone educational video games and platforms, such as Minecraft’s^{®} Education Edition^{™}, may deliver structured learning activities but may not seamlessly integrate into widespread gaming ecosystems familiar to students, thereby limiting the appeal and effectiveness. Many learners may be constrained by grade-level pacing, limited tutoring access, and disconnected data systems that may inhibit fluid movement between educational environments.

The realm of gaming and education may include initiatives such as Roblox^{®} Education and broader attempts by platforms like Minecraft^{®} to introduce educational elements, yet there may remain a considerable gap when it comes to broad curriculum integration. Certain platforms may blend educational content into gaming environments but may lack comprehensive curriculum integration, limiting effectiveness in educational settings. Language learning applications similarly may employ gamification yet may remain isolated from mainstream gaming platforms, thereby restricting potential cross-platform connectivity that could enhance learning motivation and engagement. The separation between educational tools and popular gaming environments may result in lower student engagement, as students may have to switch between different systems rather than accessing educational content in familiar and preferred gaming environments. Learners who lack learning management system access entirely may not benefit from school-centered orchestration, mastery tracking, or personalized advancement opportunities that may be available to those within institutional frameworks.

Certain game-based education platforms may face limitations related to integration with tailored curriculum content that directly corresponds to the standards of individual educational institutions and associated requirements. These platforms may require extensive manual customization by educators, which may be time-consuming and may not uniformly align with educational objectives across diverse educational systems. Other platforms may lack advanced adaptive learning capabilities that fully incorporate artificial intelligence-driven analytics to dynamically adapt lessons based on instant performance feedback from students. This may potentially result in a one-size-fits-all approach rather than a highly personalized learning path that adjusts to individual student needs, skill levels, and learning preferences. Certain platforms may operate within technological silos, lacking seamless integration with mainstream gaming platforms and other educational ecosystems, which may further compound these challenges.

Online education platforms may also face challenges related to assessment and feedback mechanisms. Certain online game-based systems may offer commendations and achievements that might not directly translate into educational assessments or academic credentials recognized by educational institutions. This may result in difficulty quantifying learning outcomes and incorporating such metrics into educational evaluation systems used by schools and districts. Furthermore, certain online education platforms may lack in-game incentives that keep students engaged and competitive within the game environment and with learning goals, reducing the motivational impact that reward systems could otherwise provide. The disconnect between gameplay achievements and academic recognition may create barriers to meaningful assessment of student progress and mastery.

Integrating education with modern digital technologies such as augmented reality and virtual reality may remain limited in certain educational platforms. Addition of augmented reality and virtual reality aspects may enhance immersion and provide tangible context to theoretical concepts but may not be fully utilized within the confines of certain game-based educational systems. Without augmented reality and virtual reality enhancements, these platforms may not fully engage students who may experience varied cognitive learning benefits from sensory-rich environments. The disconnect between educational content delivery and immersive technology applications may limit the potential for creating engaging, memorable learning experiences that employ spatial and experiential learning modalities. Certain learners may experience restricted access to tutoring resources and may be unable to progress beyond nominal grade-level placement even when mastery of content might otherwise support acceleration.

There is a continuing need for improved systems and methods providing an educational and interactive gaming environment for curriculum-based learning experiences, enhanced by generative artificial intelligence to facilitate rewards-based educational content across gaming ecosystems. Desirably, such systems would seamlessly integrate with popular gaming platforms to deliver curriculum-aligned educational content while maintaining student engagement through immersive ‘metaverse’ experiences, e.g., three-dimensional environments that a student may "walk around in" using a digital avatar in a real-time virtual space, and would establish a unified learning architecture that may operate across school-managed learning management system environments and direct-to-consumer platforms.

### SUMMARY

In concordance with the instant disclosure, systems and methods providing an educational and interactive gaming environment for curriculum-based learning experiences, enhanced by generative artificial intelligence to facilitate rewards-based educational content across gaming ecosystems, have surprisingly been discovered.

The present technology includes ways of integrating curriculum-based education platform that allow a student to access and manage custom courses and other educational content, and an accompanying experience platform that may generate, manage, and monitor an experience within virtual interactive gaming environments such as Roblox^{®}, Fortnite^{®}, Minecraft^{®}, and the like. For example, the present technology may include ‘metaverse’ based environments, e.g., a collective, immersive three-dimensional virtual space that merges physical and digital realities, allowing students to interact with each other in real-time using digital avatars for educational and social activities. The present technology includes an education platform with a dashboard for accessing student course information and interfacing with the experience platform, where the experience platform may dynamically generate an experience within the gaming environment for the student to engage with education content. The present technology may also provide digital incentives based on the academic performance of the student within gaming environments to increase student engagement in a familiar, interactive setting.

The present technology may also find applicability in various contexts, including educational settings across K-12, secondary, adult learning, and professional credentialing environments, such as institutional learning management system deployments, direct-to-consumer metaverse platforms, homeschool pathways, examination preparation programs including the American College Testing (ACT), the Scholastic Assessment Test (SAT), the Law School Admission Test (LSAT), and Medical College Admission Test (MCAT) readiness tracks, state-board licensure preparation for physicians, nurses, builders, commercial driver licensing candidates, and continuing-education renewal programs, among other learning and assessment scenarios. The present technology contemplates the use of various applications and may be implemented and described herein through a system that provides, for example, adaptive diagnostics, artificial intelligence-driven tutoring, personalized learning pathways, curriculum-based challenges delivered through gaming environments, real-time progress analytics, rewards-based engagement, learning management system interoperability, metaverse-native educational content delivery, blockchain-backed credentialing, parental controls, and multi-jurisdiction standards alignment. It should be understood that the present technology is not limited to gaming-integrated educational applications and may also be used in the above-mentioned and other circumstances. The present description of gaming-integrated and metaverse-based educational implementations provides an illustrative example of the present technology that is non-limiting and used solely as a model in describing the present technology.

In certain embodiments, a system for implementing curriculum-based educational activities for a student within an interactive gaming environment is provided. The system may include a processor and a memory. The memory may store a management module that may receive educational data and provide the educational data to an education platform. The education platform may provide the educational data to the student via a dashboard and may provide the educational data to an analytics module. The analytics module may correlate the educational data to a placement that may be a mastery level, a learning gap, or a readiness level for advanced content. An artificial intelligence (AI) agent may generate placement content from the placement for incorporation in a game-instance. A content generation module may generate the game-instance within an experience platform based on the placement content via the AI agent. The experience platform may generate an experience within the interactive gaming environment, wherein the experience may include the game-instance and the placement content.

In certain embodiments, a non-transitory computer-readable medium is provided, operable to store processor instructions for implementing curriculum-based educational activities for a student within an interactive gaming environment. When the processor instructions may be executed by a processor, the processor instructions may cause the processor to receive, via a management module, educational data and provide the educational data to an education platform. The processor instructions may cause the processor to provide, via the education platform, the educational data to the student via a dashboard and provide the educational data to an analytics module. The processor instructions may cause the processor to correlate, via the analytics module, the educational data to a placement, the placement including a mastery level, a learning gap, or a readiness level for advanced content. The processor instructions may cause the processor to generate, via the AI agent, the placement content from the placement for incorporation in a game-instance. The processor instructions may cause the processor to generate, via a content generation module, the game-instance within an experience platform based on the placement content via the AI agent. The processor instructions may cause the processor to generate, via the experience platform, an experience within the interactive gaming environment, wherein the experience may include the game-instance and the placement content.

In certain embodiments, a method for delivering curriculum-based educational activities for a student within an interactive gaming environment is provided. The method may include a step of providing the system for implementing curriculum-based educational activities for a student within an interactive gaming environment described herein above. The method may include a step of receiving, via the management module, the educational data and providing the educational data to the education platform. The method may include a step of providing, via the education platform, the educational data to the student via the dashboard and providing the educational data to the analytics module. The method may include a step of correlating, via the analytics module, the educational data to the placement. The method may include a step of generating, via the AI agent, the placement content from the placement for incorporation in the game-instance. The method may include a step of generating, via the content generation module, the game-instance within the experience platform based on the placement content. The method may include a step of generating, via the experience platform, the experience within the interactive gaming environment, wherein the experience may include the game-instance and the placement content.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIGS. 1A-1D are block diagrams each illustrating an embodiment of a system for implanting curriculum-based educational activities for a student within an interactive gaming environment;

FIGS. 2A-2F illustrate examples of the experience platform;

FIGS. 3A-3J illustrate examples of the education platform;

FIGS. 4A and 4B provides a flowchart illustrating an embodiment of a method for delivering curriculum-based educational activities for a student within an interactive gaming environment;

FIG. 5 provides a flowchart extending from FIGS. 4A and 4B and further illustrates a method for delivering curriculum-based educational activities for a student within an interactive gaming environment; and

FIG. 6 provides a flowchart extending from FIGS. 4A and 4B and further illustrates a method for delivering curriculum-based educational activities for a student within an interactive gaming environment.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps may be different in various embodiments, including where certain steps may be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X may have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed contents.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

The present technology provides an educational platform and a ‘metaverse’ based experience platform that brings curriculum-based learning into gaming environments students already enjoy. Students may be guided through personalized lessons that dynamically adapt to the skill level of the student. In other words, artificial intelligence tutoring may be delivered in real time, adjusting difficulty as learners progress. Parents and educators may be given visibility into student performance and mastery. Digital rewards may be earned through academic achievement, increasing motivation and engagement. Learning may be accessed through a school system or directly through the experience platform. Students may be challenged beyond grade-level constraints when readiness may be demonstrated.

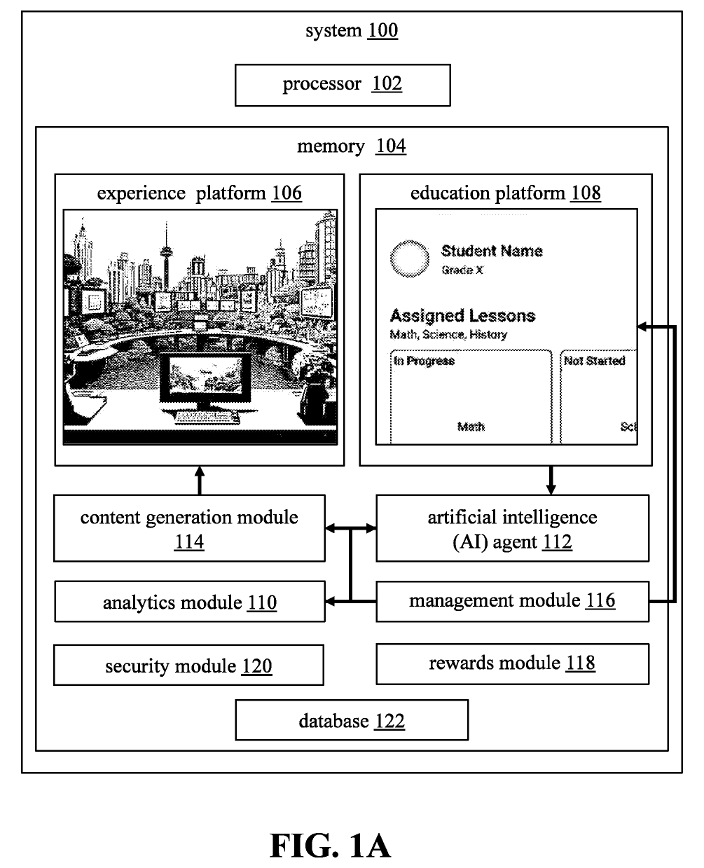

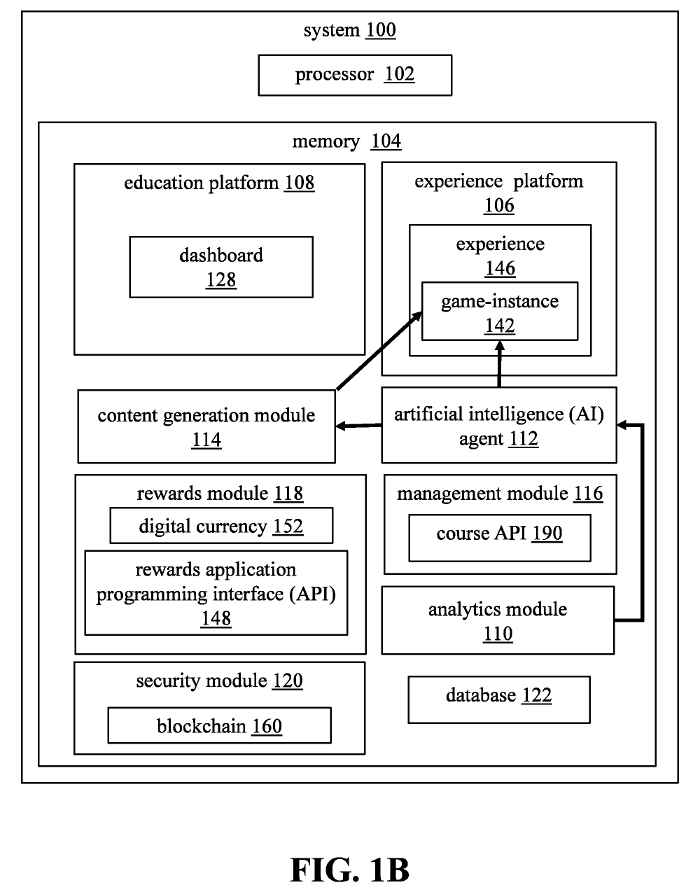

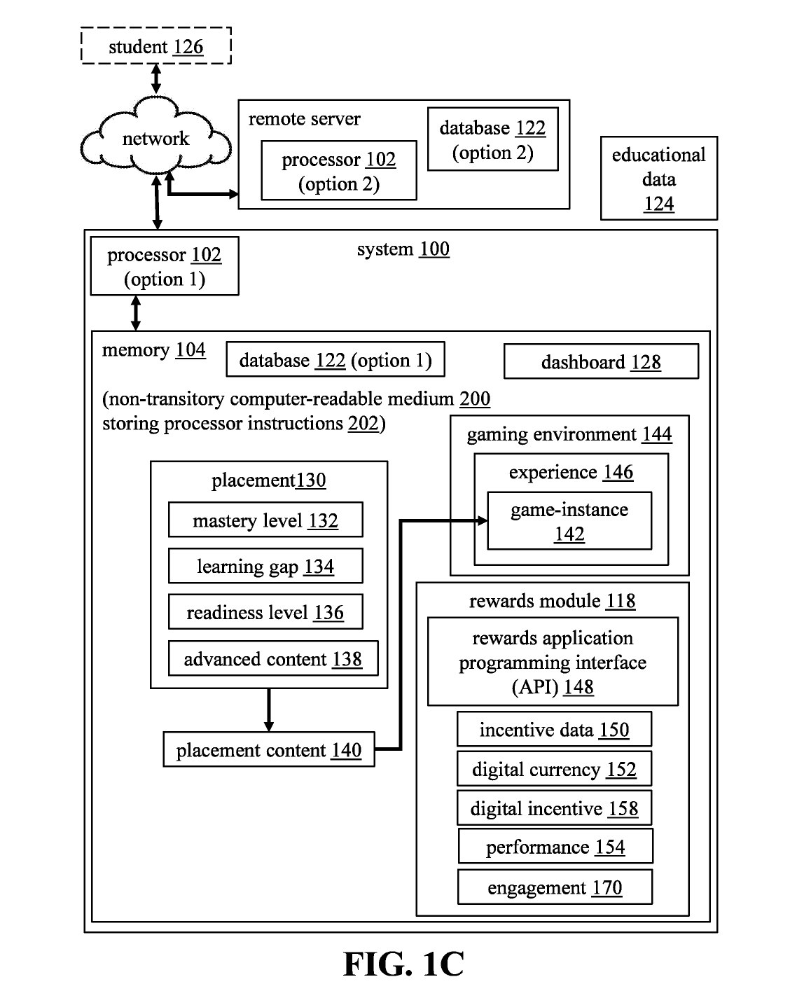

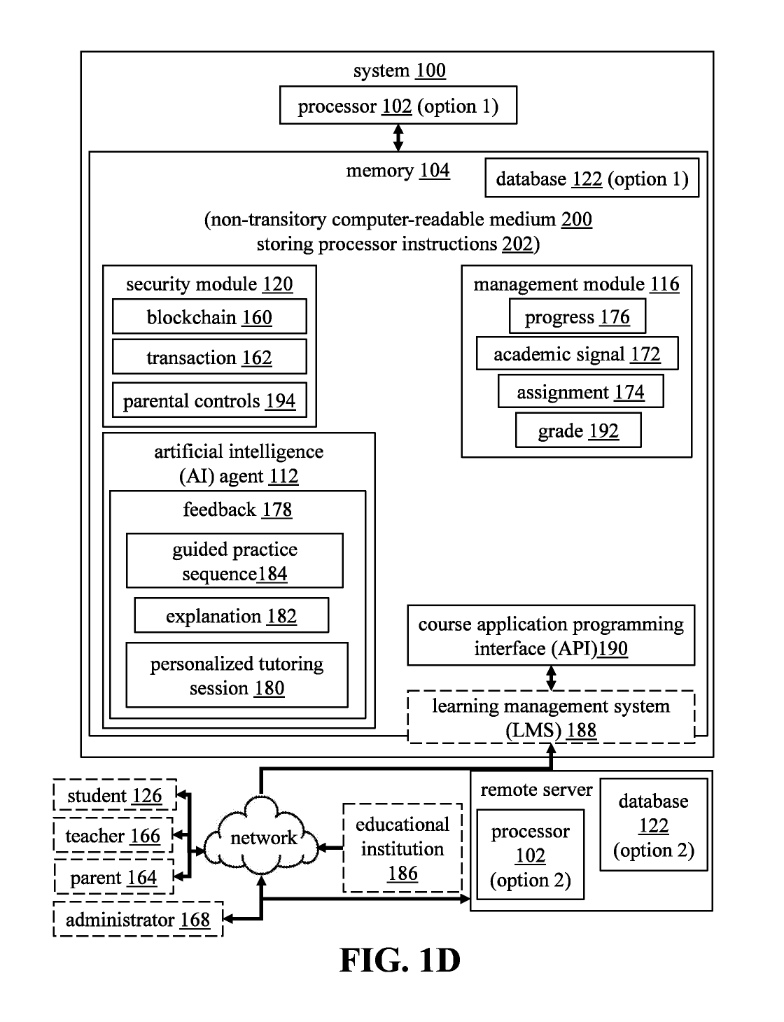

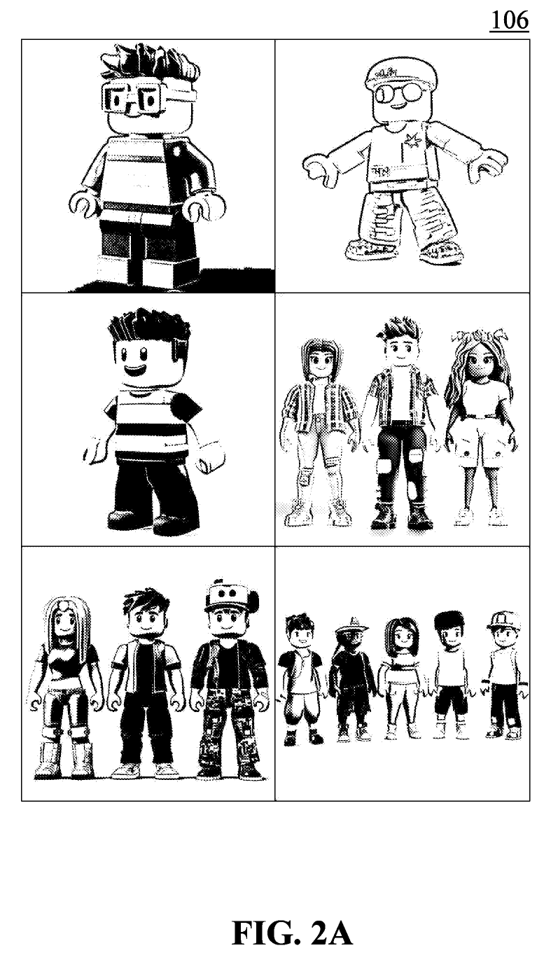

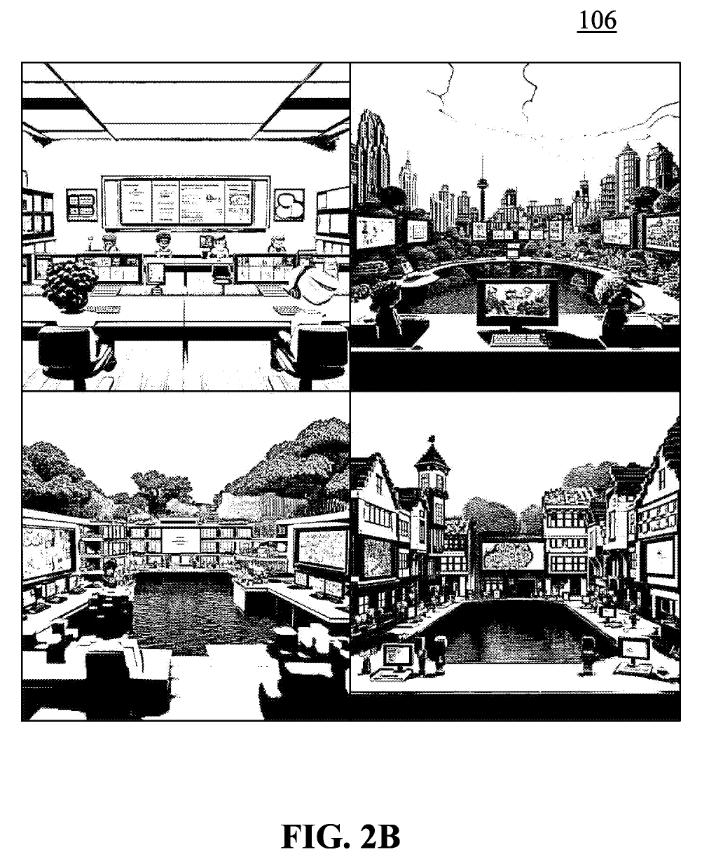

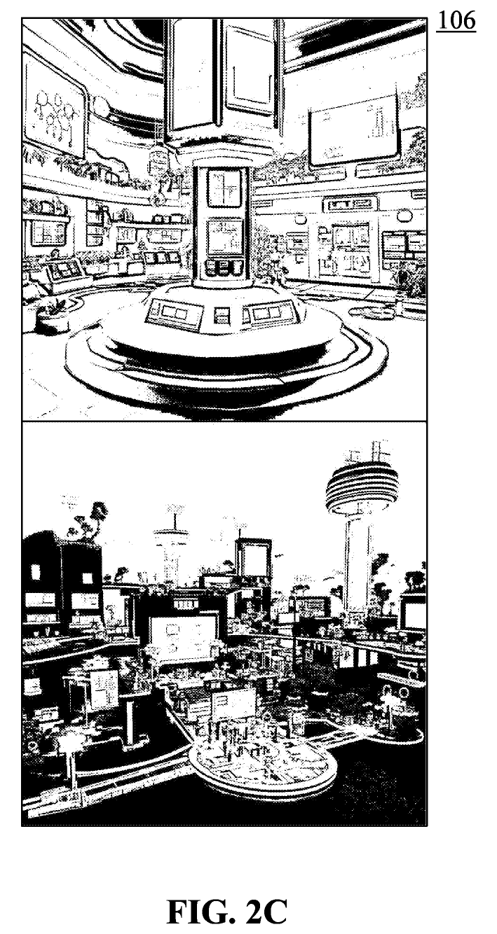

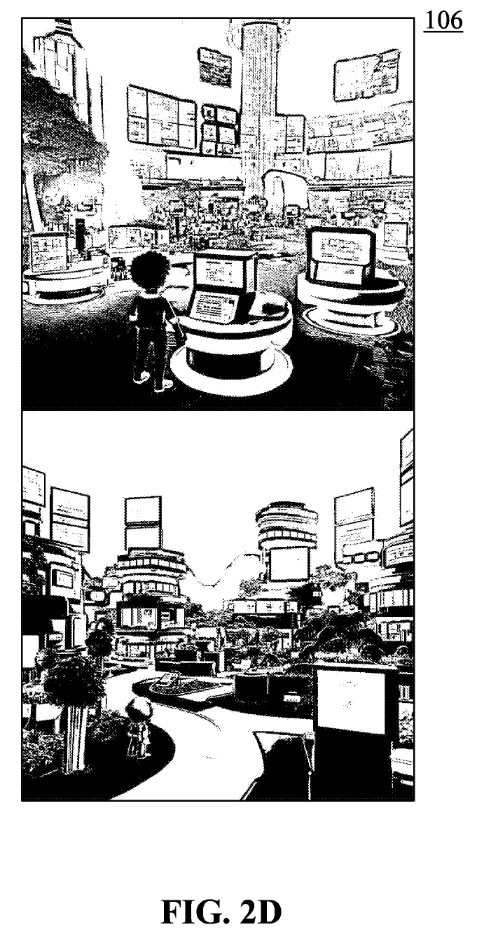

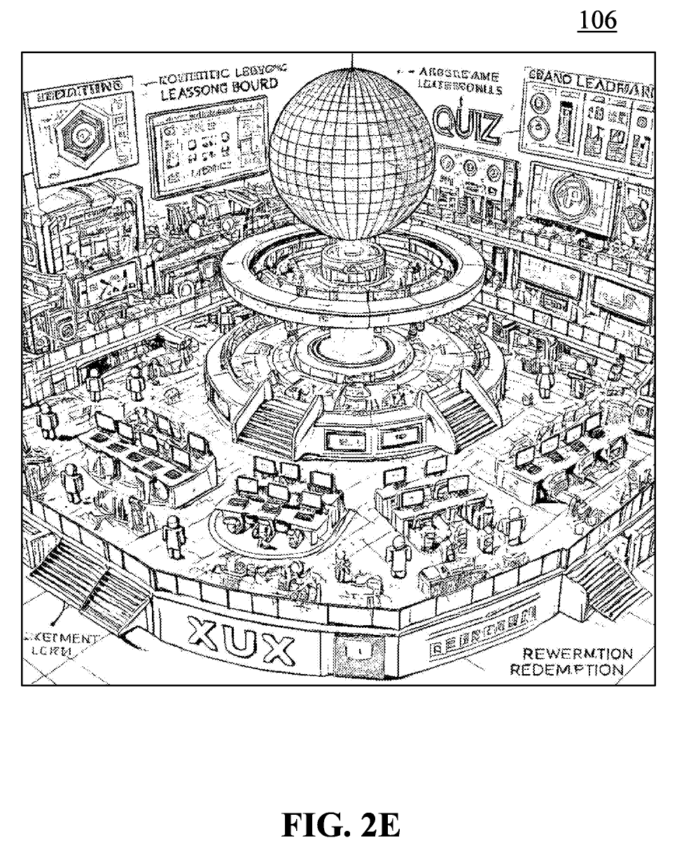

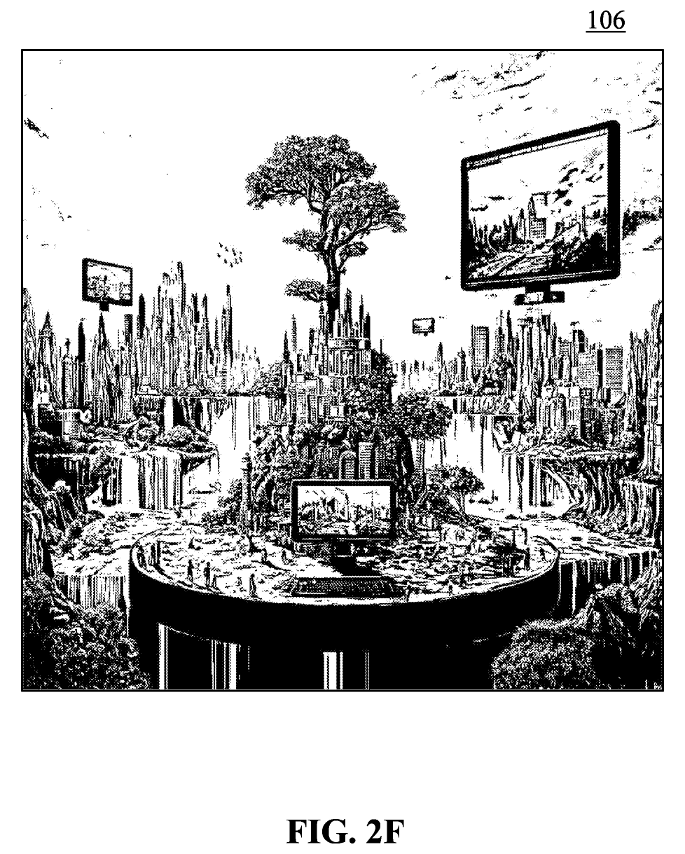

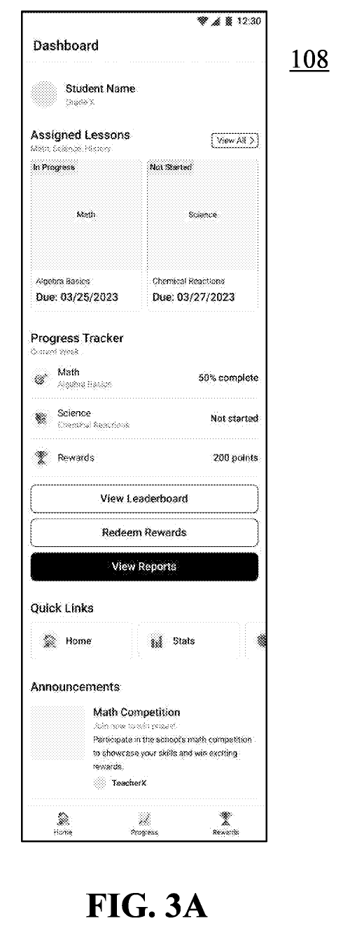

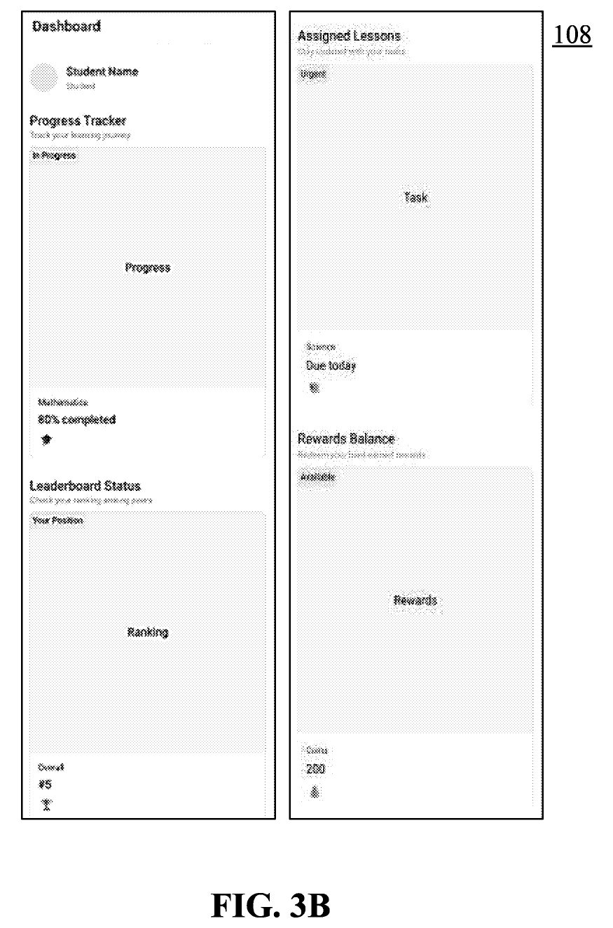

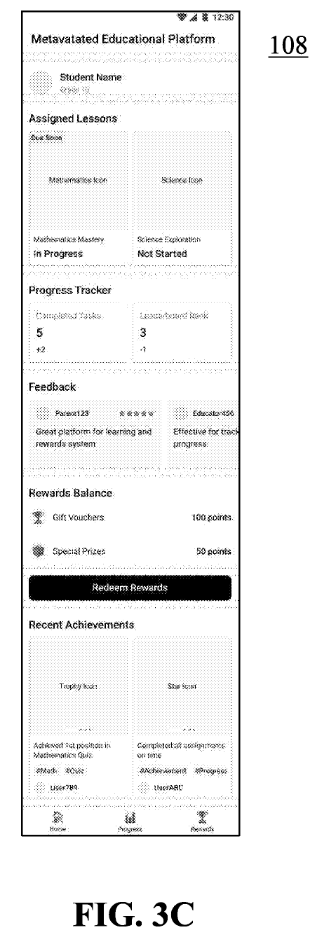

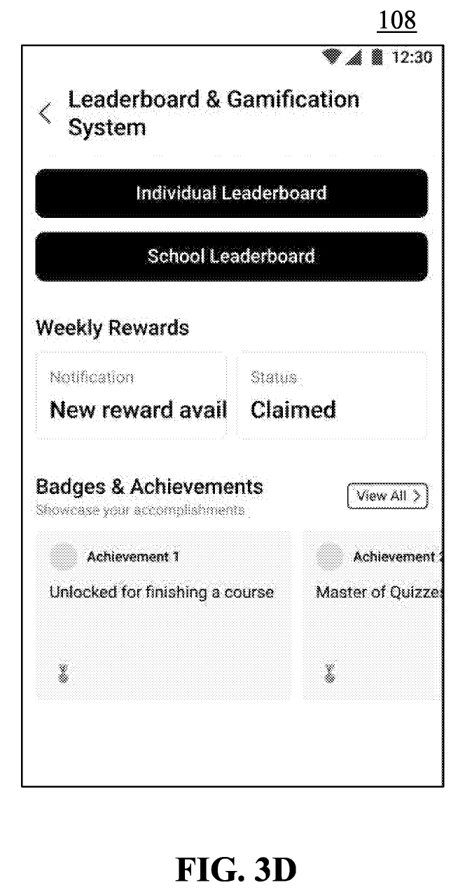

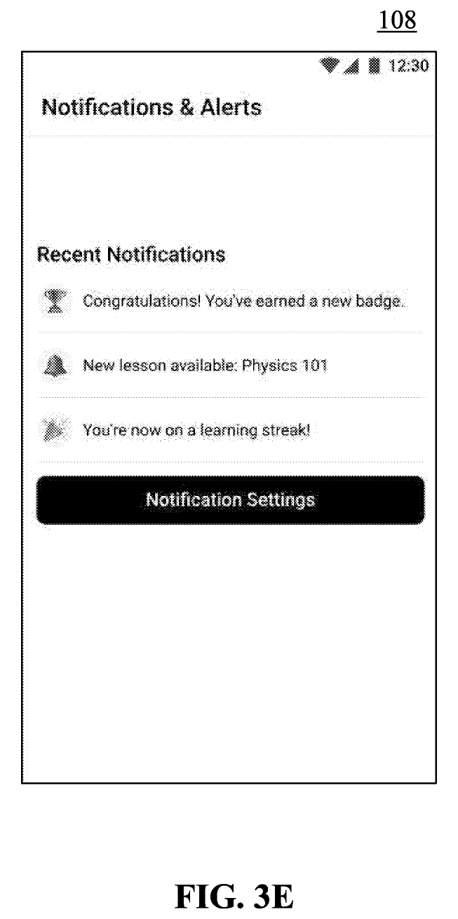

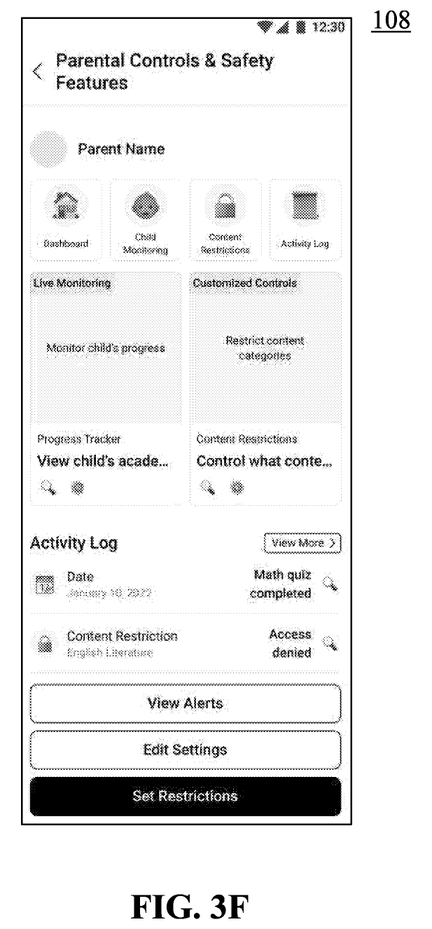

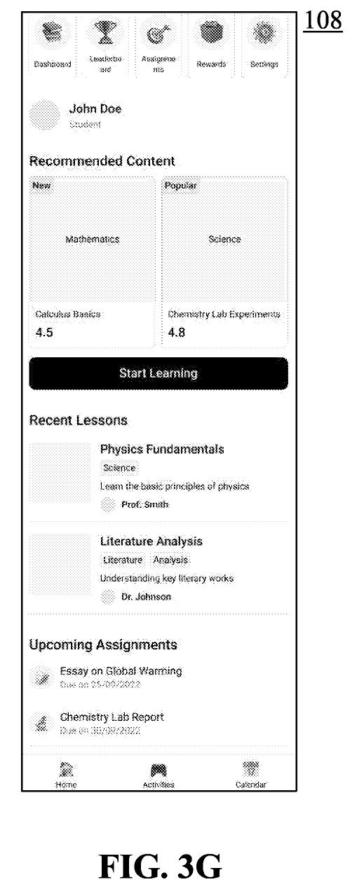

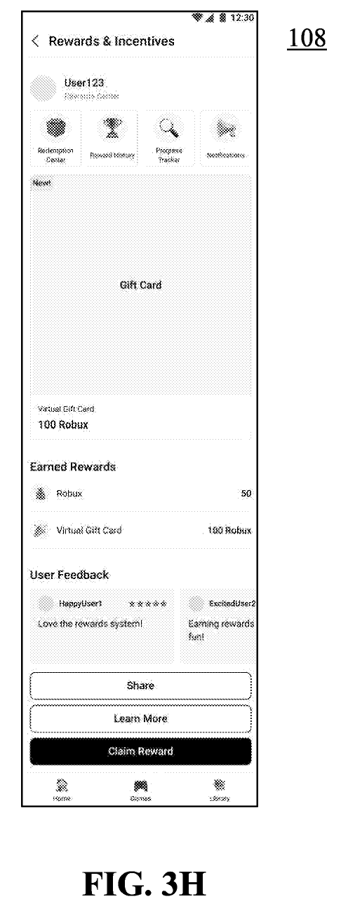

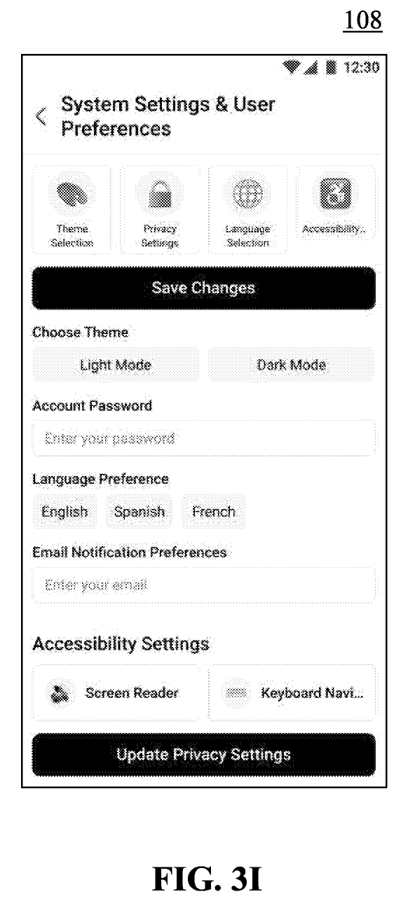

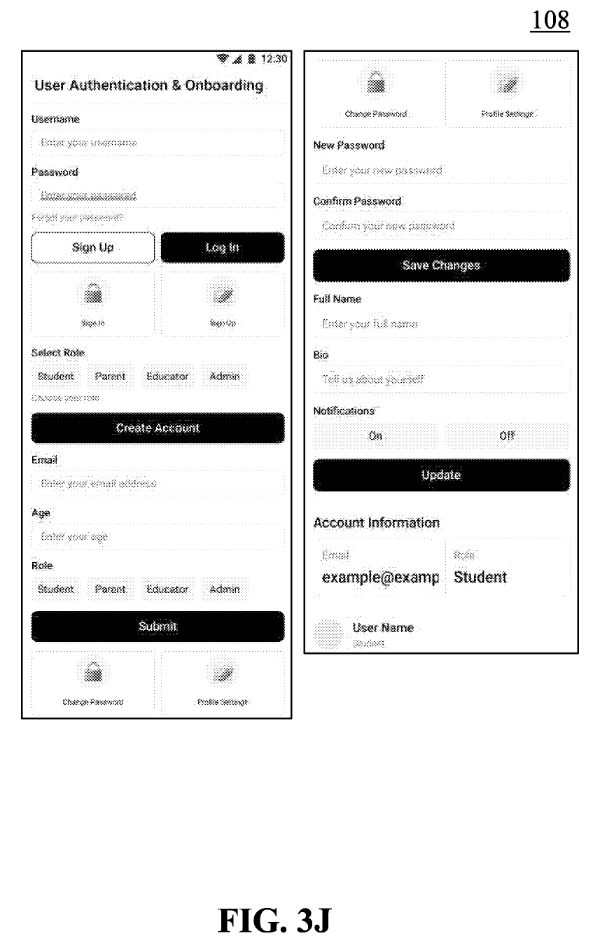

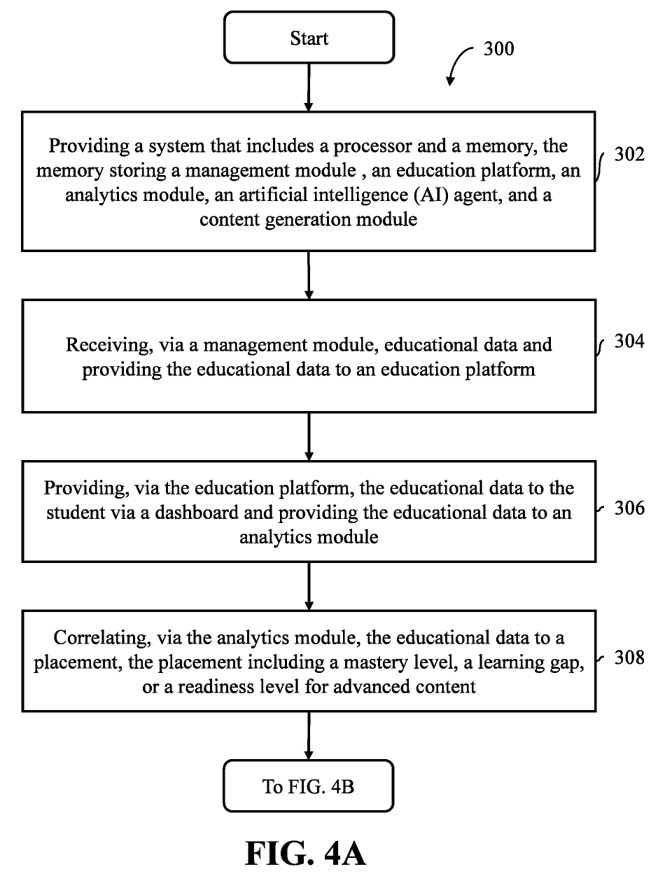

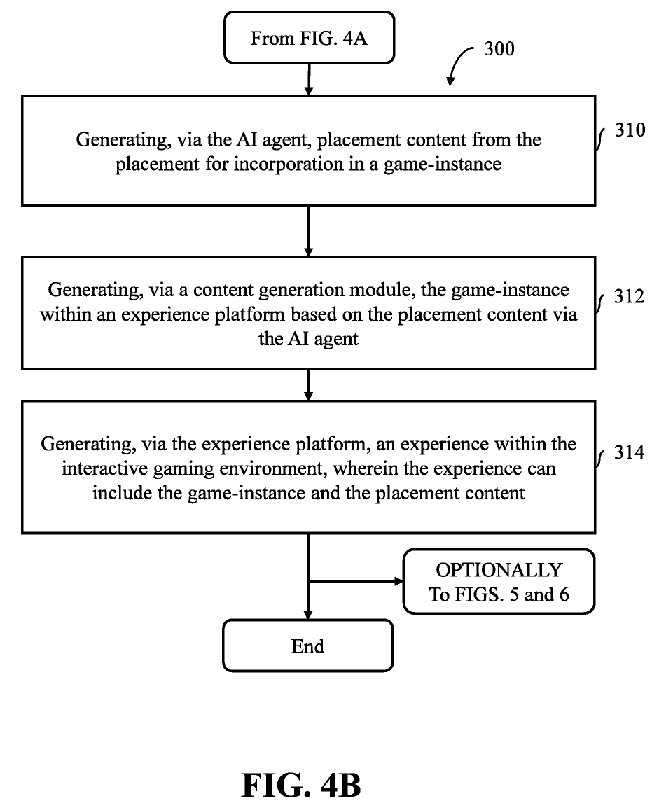

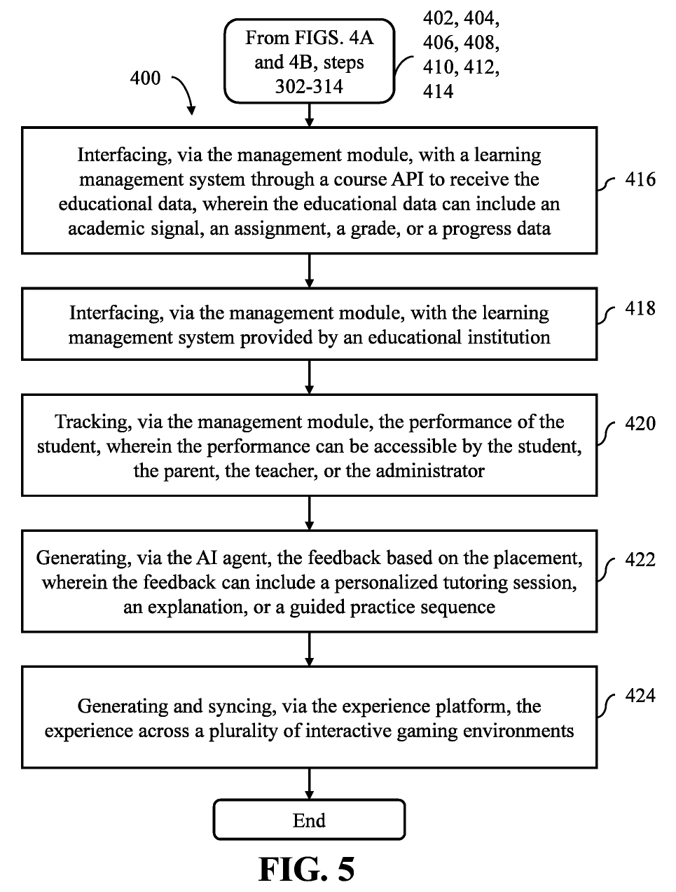

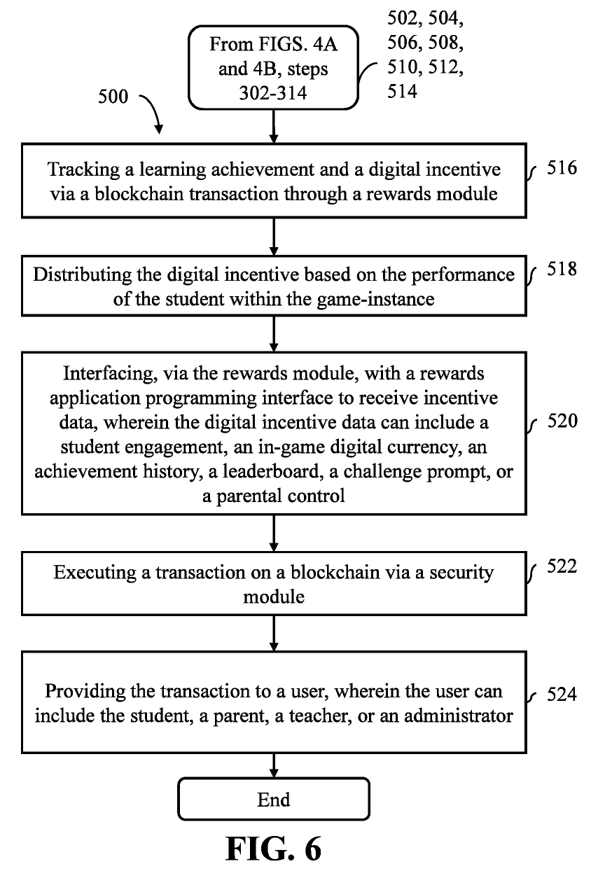

Ways for implementing curriculum-based educational activities for a student within an interactive gaming environment are provided, aspects of which are shown generally in accompanying FIGS. 1-6. The present technology provides a system 100 and non-transitory computer-readable medium 200 for implementing curriculum-based educational activities for a student within an interactive gaming environment, aspects of which are shown generally in accompanying FIGS. 1-3J. A method 300 for delivering curriculum-based educational activities for a student within an interactive gaming environment is also provided, aspects of which are shown in FIGS. 4A and 4B. Another method 400 for delivering curriculum-based educational activities for a student within an interactive gaming environment is also provided, aspects of which are shown in FIG. 5. Yet another method 500 for delivering curriculum-based educational activities for a student within an interactive gaming environment is also provided, aspects of which are shown in FIG. 6.

The system 100, and non-transitory computer-readable medium 200, and methods 300, 400, and 500 allow for personalized learning through games that adapt to each student's skill level and reward progress. As shown in FIGS. 1-3J, the system 100 may include a processor 102 and a memory 104. The memory 104 may include an experience platform 106, an education platform 108, an analytics module 110, an artificial intelligence (AI) agent 112, content generation module 114, a management module 116, a rewards module 118, a security module 120, and a database 122. The content generation module 114 may obtain educational data 124 and transmit the educational data 124 to the education platform 108, which may deliver the educational data 124 to the student 126 through a dashboard 128 and forward the educational data 124 to the analytics module 110. The analytics module 110 may determine a placement 130 representing a mastery level 132, learning gap 134, or readiness level 136 for advanced content 138. The AI agent 112 may create placement content 140 for incorporation into a game-instance 142, which the content generation module 114 may build within the experience platform 106. The experience platform 106 may produce an interactive gaming environment 144 experience 146 containing the game-instance 142 and placement content 140. The rewards module 118 may connect with a rewards API 148 to obtain incentive data 150 and distribute digital currency 152 based on student 126 performance 154. The security module 120 may record learning achievements and digital incentives 158 via blockchain 160 transactions 162 accessible to students 126, parents 164, teachers 166, or administrators 168. The database 122 may maintain educational data 124, placements 130, placement content 140, game-instances 142, experiences 146, performance data, and incentive data 150.

The processor 102 may control the system 100 to execute various modules and components for curriculum-based educational operations. One skilled in the art will also appreciate that the processor 102 may include one or more processors and may process information and execute the various instructions or operations, as described herein. The processor 104 may include a local processor, shown as the processor 104 option 1 in FIGS. 1C-1D; saved on a remote server and accessed via a network, shown as the processor 104 option 2 in FIGS. 1C-1D, such as a cloud server; or a combination of a local and a remote processor 104, as required by the system 100. For example, the processor 102 may include a central processing unit (CPU), a microprocessor, a microcontroller, a system-on-a-chip, a digital signal processor (DSPs), field-programmable gate arrays (FPGAs), application-specific integrated circuits (ASICs), and/or a processor based on a multi-core processor architecture. One or more processors 102 may mean a single processor or multiple processors in a single processing unit, e.g., a central processing unit, or multiple processing units, e.g., a central processing unit and a graphics processing unit, or a central processing unit and a memory manager. The processor 102 may include multiple processors where one processor is capable of executing one or more of the elements described in this disclosure, and a subsequent processor or processors may execute other elements as described herein, capable of executing all elements only in combination. It should be understood that one or more of the processors 102 may be remote from the at least one local system server.

The memory 104 may be in communication with the processor 102 and may include both volatile and non-volatile memory 104 components. The memory 104 may store program instructions, operating software, and applications required for secure document processing operations. The memory 104 may include additional modules that work together to provide comprehensive document management capabilities for students learning through interactive games. The memory 104 may implement secure memory handling, for example, cryptographic memory wiping after processing to ensure sensitive data does not persist in temporary storage. The memory 104 may store or otherwise include one or more databases 122. The memory 104 may include one or more memories of any type suitable to the system 100 and may be implemented using any suitable volatile or nonvolatile data storage technology such as a semiconductor-based memory device, a magnetic memory device, an optical memory, a fixed memory, and/or a removable memory. For example, the memory 104 may include any combination of random-access memory (RAM), read only memory (ROM), static storage such as a magnetic or optical disk, a hard disk drive (HDD), or any other type of non-transitory machine or computer readable media.

The experience platform 106 may be adapted to generate, manage, and monitor an experience 146 within interactive gaming environments 144. The experience 146 may be a ‘metaverse’ where students 126 may share a persistent immersive virtual world where student avatars may interact, socialize, and engage in educational activities. The experience platform 106 may generate the metaverse experience 146 for popular online games such as Roblox^{®}, Fortnite^{®}, and Minecraft^{®}. Once generated, the student 126 may log into a personal account on the gaming environment 144 and access the experience 146 via the experience platform 106. The experience 146 may include multiple game-instances 142 for the student 126 that may cover multiple courses and course topics.

The experience platform 106 may provide personalized educational sessions through the game-instance 142 where the student 126 may complete coursework, tests, or quizzes. When the student 126 chooses a game-instance 142 within the experience 146, the avatar of the student 126 may phase out of the experience 146 and into the game-instance 142 where the student 126 may complete the course, task, test, or quiz privately. The game-instance 142 may be created by the content generation module 114 via the AI agent 112 and may be accessible to the student 126 via the experience platform 106. Each time the student 126 enters the game-instance 142, the atmosphere and course content or quiz questions may be unique to encourage increased efforts in studying. The game-instance 142 may be regenerated in real-time, rendering surroundings and course content unique to the last attempt in a previous game-instance 142.

The experience platform 106 may be adapted to generate and sync an experience 146 across a plurality of interactive gaming environments 144. The experience platform 106 may feature a cross-platform accessibility framework that may allow the student 126 to access experiences 146 across multiple gaming environments 144 without the need to log out from any single gaming environment 144. The cross-platform accessibility framework may allow a student 126 to stay logged in across various devices, such as computers, tablets, or gaming consoles, providing a flexible and convenient learning experience. Administrators, educators, students 126, and parents may monitor real-time academic progress, assignment completion, in-game achievements, and screen time analytics between multiple gaming environments 144 for each student 126.

The experience platform 106 may incorporate augmented reality (AR) and virtual reality (VR) technologies to enhance the educational content. Students 126 may have the opportunity to engage with immersive 3D models, simulations, and interactive lessons, which may provide a deeper understanding of complex subjects. The AR and VR integration may support varied learning styles by offering visual, auditory, and kinesthetic learning elements within the game-based setting. The immersive gameplay may encourage the student 126 to spend time within the experience 146 instead of playing in the gaming environment 144 outside the experience 146.

The education platform 108 may be adapted to facilitate access to the experience platform 106 and manage the educational data 124. The education platform 108 may be accessed via a smartphone application, desktop application, web browser, or similar computing interface. The education platform 108 may receive the educational data 124 from the management module 116 and provide the educational data 124 to the student 126 via the dashboard 128. The education platform 108 may also provide the educational data 124 to the analytics module 110 for correlation to the placement 130. The education platform 108 may serve multiple user roles, including the student 126, parent 164, teacher 166, and administrator 168, wherein each user role may access role-specific information and functionality through the dashboard 128.

The education platform 108 may utilize the dashboard 128 as a unified interface through which users interact with the system 100. The dashboard 128 may include a student dashboard, a parent dashboard, a teacher dashboard, and an administrator dashboard, wherein each dashboard type may display information and controls tailored to the respective user role. The student dashboard may display the account information of the student 126, assigned lessons, progress tracking, announcements from the school, teacher 166, or classmates, and system notifications. The student dashboard may also display the progress for each educational topic assigned to the student 126, the status of leaderboards that the student 126 participates in, a list of assigned lessons, and the balance of rewards earned by the student 126. The education platform 108 may notify the student 126 of upcoming assignments and deadlines through the notification system.

The education platform 108 may include, via the dashboard 128, a main menu, a user authentication and onboarding menu, a leadership menu, a rewards and incentives menu, a notifications and alerts menu, a system settings and user preferences menu, and a parental controls and safety menu. The user authentication and onboarding menu may allow the student 126, teacher 166, or parent 164 to create a username and password to sign in to the education platform 108 and sign up for in-game education. The user authentication and onboarding menu may allow users to provide personal identifiers such as name, role, biography, and other account information. The user authentication and onboarding menu may utilize quick response (QR) codes, short message service (SMS) codes, email verification, and push notifications when authenticating the identity of the student 126, teacher 166, or parent 164.

The education platform 108 may be programmed so that the dashboard 128 interacts with hardware including various output devices that may display a representation of the platform for observation by the user, where such an output device may include, for example, one or more computer screens, speakers, tablet screens, television screens, smartphone screens, printers, or other view/audio ports. The dashboard 128 may include, for example, a graphical user interface that may be displayed in various ways, for example, via a desktop application, smartphone, tablet, tv, mobile application, web interface, or API, and may interface with mobile short message service (SMS), social platforms, or messaging applications. The dashboard 128 may be intuitive and user-friendly, for example, with custom user preferences and accessibility requirements, allowing the user to easily upload documents or data for later use, or allow the user to retrieve a generated or uploaded document or data.

The education platform 108 may display a leadership menu for the gamification elements of the system 100, including weekly rewards, badges, achievements, and notifications. The leadership menu may display individual leaderboards, class leaderboards, or school leaderboards, wherein the leaderboards may receive updated data from the rewards module 118 and display ranking information for the student 126, teacher 166, and classmates to view. The rewards and incentives menu may display reward history, redeemable gifts, gift cards to respective gaming environments 144 in the form of digital currency 152, and student feedback. The rewards and incentives menu may send and receive data from the rewards module 118 for providing notices and alerts to the student 126 or parent 164 regarding the status of the rewards and digital currency earned by the student 126.

The education platform 108 may send and receive communications through a notifications and alerts menu such as when the student 126 earns a new badge, when new lessons become available, or when the student 126 achieves a learning streak to earn a streak bonus. The student 126 may adjust notification settings through the education platform 108 to customize the level of focus and involvement. The education platform 108 may include a notification center that may be in communication with the database 122 to access user preferences and notification data. The system settings and user preferences menu may display options for themes, privacy settings, language selection, accessibility options, and notification preferences, wherein themes may include a light mode and dark mode for ease of reading in different atmospheric lightings, and accessibility options may include a screen reader for visually impaired students and a keyboard navigation for devices that lack a mouse or track pad.

The education platform 108 may implement a parental controls and safety menu available to parent accounts for monitoring and controlling the educational activities of the student 126. The parent 164 may view the account information of the student 126, including live monitoring of educational progress, customizing controls, viewing activity logs, setting content restrictions, and viewing alerts. The parental controls and safety menu may allow the parent 164 to set a time limit or screen time controller for the student 126, managing how many hours the student 126 may spend in an experience 146 via the experience platform 106. The parent 164 may also filter unwanted content and control access based on whether the student 126 completes educational objectives. The parental controls and safety menu may send alerts to the parent 164 when screen time has been exceeded or when the student 126 has achieved certain objectives to earn additional screen time.

The analytics module 110 may be adapted to correlate the educational data 124 to a placement 130. The placement 130 may represent a mastery level 132, a learning gap 134, or a readiness level 136 for advanced content 138. The analytics module 110 may receive the educational data 124 from the education platform 108 and analyze the performance 154 of the student 126 in real-time. The analytics module 110 may utilize diagnostic assessments to establish the current proficiency of the student 126 through question sequences that may measure comprehension and skill retention. The analytics module 110 may compile performance metrics such as completion time, accuracy of responses, and frequency of engagement 170 to determine the appropriate placement 130 for the student 126.

The analytics module 110 may identify deficiencies in the understanding of the student 126 and determine a readiness level 136 for acceleration to more advanced content 138. The analytics module 110 may work in conjunction with the AI agent 112 to analyze patterns in the educational data 124 and generate insights into the progress 176 of the student 126. The analytics module 110 may provide recommendations for remediation, on-grade content, or above-grade content based on the demonstrated readiness level 136 of the student 126. The placement 130 determined by the analytics module 110 may be provided to the AI agent 112 for generating personalized placement content 140 tailored to address the mastery level 132, learning gap 134, or readiness level 136 of the student 126. The analytics module 110 may track the progress 176 of the student 126 across multiple courses and subjects to create comprehensive learning profiles that may inform future placements 130.

The AI agent 112 may be adapted to generate placement content 140 from the placement 130 for incorporation in a game-instance 142. The AI agent 112 may be stored locally on the memory 104 or accessed remotely via an application programming interface (API) or remote server. The AI agent 112 may incorporate the educational data 124 within the game-instance 142 based on the performance 154 of the student 126 in real-time. The AI agent 112 may work in conjunction with the content generation module 114 to assist the generation process of the game-instance 142 inside the experience 146 so that each time the student 126 enters the game-instance 142, the atmosphere and course content or quiz questions may be unique. The placement content 140 generated by the AI agent 112 may be tailored to address the mastery level 132, learning gap 134, or readiness level 136 determined by the analytics module 110.

The AI agent 112 may be adapted to generate feedback 178 based on the placement 130. The feedback 178 may include a personalized tutoring session 180, an explanation 182, or a guided practice sequence 184. The AI agent 112 may enable adaptive learning paths that may dynamically adjust in complexity and content based on student interactions within the gaming environment 144. The AI agent 112 may tailor a recommendation for the next learning activity of the student 126, wherein the recommendation may be a suggestion provided to the student 126 via the education platform 108 to review a specific lesson, try an additional practice quiz, or proceed to the next difficulty level. The AI agent 112 may analyze performance metrics including completion time, accuracy of responses, and frequency of engagement 170 to provide educators with insights into the progress 176 of the student 126 and areas needing improvement.

The content generation module 114 may be adapted to generate the game-instance 142 within the experience platform 106 based on the placement content 140 via the AI agent 112. The content generation module 114 may create each game-instance 142 for an individual student 126 where only that student 126 may access the game-instance 142 if the student 126 enrolls in a certain course. Alternatively, the content generation module 114 may generate a game-instance 142 for multiple students 126 to engage with for group assignments or group study. The content generation module 114 may create surrounding objects, background, and world aesthetics of the experience 146 in order to tailor the learning atmosphere to each student 126, class, educational institution 186, or course topic. The content generation module 114 may be enhanced by the AI agent 112 for customizing each game-instance 142 for each student 126 based on the analysis of the AI agent 112 and the generative requisites of each game-instance 142.

The content generation module 114 may incorporate the educational data 124 provided by the educational institution 186, the student 126, or the teacher 166 in the game-instance 142. The content generation module 114 may also generate each experience 146 based on the class, the educational institution 186, or other factors to facilitate custom-world interaction between students 126. The content generation module 114 may tailor the educational content for each game-instance 142 such as test questions, quiz variations, and learning styles. The content generation module 114 may utilize an large language model (LLM) environment generation pipeline that may include template selection by category and difficulty, prompt building with safety rules, challenge type, sponsor context, and content requirements, cache lookup, generation using local or cloud LLM providers, code extraction and injection-point replacement, and validation covering syntax, structure, safety, and earnings integrity. The content generation module 114 may dynamically regenerate the game-instance 142 each time the student 126 enters the game-instance 142 to render unique surroundings and course content.

The management module 116 may be adapted to retrieve educational data 124 from an educational institution 186 and provide the educational data 124 to the education platform 108 and the content generation module 114 and the AI agent 112 for generating game-instances 142. The management module 116 may receive information relating to student 126 courses through a course application programming interface (API) 190. The course API 190 may receive and send information from the student 126, the teacher 166, or the parent 164 to and from the educational institution 186. The course API 190 may provide information on course modules, enrollment information, course information including whether the student 126 requires prerequisites, lessons, course progress, any attempts made to complete a course by the student 126, certifications, course content, and course assessments. The course API 190 may send and receive data from a learning management system 188 such as Schoology^{®}, Blackboard^{®}, Google’s Google Classroom^{™}, Canvas^{®}, Moodle^{®}, and similar platforms.

The management module 116 may be adapted to track the performance 154 of the student 126, wherein the performance 154 may be accessible by the student 126, the parent 164, the teacher 166, or the administrator 168 via the dashboard 128 of the education platform 108. The management module 116 may include or be in communication with a database 122 to store information relating to the student 126, course management data, and rewards records. The database 122 may store information relating to an individual student 126, class, educational institution 186, or an entire student 126 population that utilizes the system 100. The database 122 may include the personal information of the student 126, the learning preferences of the student 126, recommendations and feedback from the system 100, performance 154 and learning objectives, and the learning path of the student 126. The database 122 may also include course information such as enrollment, prerequisites for certain courses, lesson information, assessments and course attendance and attempts, certifications, course content, and content resources.

The management module 116 may be adapted to enable the teacher 166 to create and monitor courses, grades 192, and enrollment through administrative interface components within the education platform 108. The management module 116 may process enrollment approval workflows wherein the student 126 submits an enrollment request for a course and the system 100 records the enrollment request and sends a notification to the teacher 166 that the student 126 wants to enroll. The teacher 166 may review the information from the student 126 and ensure the student 126 meets eligibility requirements for the course. The teacher 166 may approve or reject the enrollment request, and upon teacher 166 approval the system 100 may process the approval by adding the student 126 to the course active enrollment list and notifying the student 126 that enrollment was approved and access to the course content may now be available. The system 100 may track the completion of lessons and update the student 126 learning progress to ensure the student 126 and the teacher 166 or parent 164 may later review which content has been completed.

The management module 116 may be adapted to manage content and interactions on the education platform 108 and within the experience platform 106 to comply with regulatory requirements such as the Children's Online Privacy Protection Act, General Data Protection Regulation guidelines, and other data privacy regulations and regional content standards. The AI agent 112 may detect content that might be problematic, inappropriate, or illegal, deferring the final decision to an administrator 168 via the education platform 108 to maintain platform standards and legal compliance. The system 100 may receive new content submissions and automatically trigger a content scan via the AI agent 112 for compliance checks. The AI agent 112 may analyze the content for any violations or issues, and the system 100 may alert an administrator 168 that there may be content awaiting review due to a compliance flag. The administrator 168 may review the flagged content and decide to reject the content if it violates a guideline or to approve the content for student 126 access.

The management module 116 may be adapted to coordinate with the rewards module 118 to ensure that digital incentives 158 earned by the student 126 align with educational achievement. The rewards module 118 may track all progress, attempts and completion of courses, quizzes, and tasks that the student 126 performs in a game-instance 142 through the experience platform 106. A parent 164 account may be linked for approval if the student 126 attempts to redeem rewards. The student 126 may select a reward and initiate the redemption, and the system 100 may then ask for parent 164 approval before finalizing the redemption by sending a notification to the linked parent 164 account. The parent 164 may review the request details including what the reward comprises and either approve or deny the request. Upon parent 164 approval, the system 100 may proceed with the redemption to grant the reward to the student 126.

The rewards module 118 may be adapted to provide a digital incentive 158 to the student 126 based on the performance 154 of the student 126 within the game-instance 142. The rewards module 118 may receive information relating to digital currency 152 through a rewards API 148 and may be adapted to track all progress 176, attempts, and completion of courses, quizzes, and tasks that the student 126 performs in the game-instance 142 through the experience platform 106. The rewards module 118 may be adapted to create and track periodic challenges, wherein the challenges may include daily challenges, weekly challenges, or special event challenges, and the challenges may include individual challenges for the student 126 or group challenges depending on the needs or preferences of the teacher 166 or the nature of the course. The rewards module 118 may offer virtual currency based on the gaming environment 144 that the game-instance 142 was generated for, special content provided by the gaming environment 144, experience points, or a collectable item provided by the gaming environment 144. The student 126 may earn special avatars, custom themes, exclusive badges, advanced courses, or private tutoring credits through the rewards module 118. The rewards module 118 may be adapted to offer partial rewards when the student 126 does not complete a course or a task, and may offer a streak bonus or other performance-based bonus when the student 126 excels in a course or task. The student 126 may earn virtual currency, special content provided by the gaming environment 144, experience points, or a collectable item based on other activities such as social activities, creative activities, or supportive activities.

The rewards module 118 may be adapted to allow students 126 and parents 164 to purchase, transfer, or redeem digital currency 152, wherein the parent 164 may provide the student 126 with an allowance that the student 126 may utilize in the gaming environment 144. The student 126 or parent 164 may purchase digital currency 152, or the system 100 may purchase digital currency 152 on behalf of the student 126, through secure payment services pay for subscriptions, digital currency 152, or in-game packages available in the gaming environment 144. The system 100 may utilize fraud detection to protect student 126 and parent 164 accounts, helping to reduce unauthorized transactions of digital currency 152 purchase or redemption. The rewards module 118 may include a blockchain 160 for transactions 162 for tracking a learning achievement and distributing a digital incentive 158, wherein the blockchain 160 may be employed for credentialing purposes within the system 100, ensuring that achievements and competencies acquired by students 126 in the gaming environment 144 may be securely recorded and verifiable. The system 100 may employ a local registrar or outside registrar for the blockchain 160 to retain convenient access and provide precautions against unauthorized access. The blockchain 160 may employ cryptography standards and protocols set by organizations such as Enterprise Ethereum Alliance, the World Wide Web Consortium, the International Organization for Standardization, and the Institute of Electrical and Electronics Engineers, and may include post-quantum cryptography to ensure the safety and security of personally identifiable information of the student 126 and parent 164.

The rewards API 148 may be adapted to receive and send information relating to the points that the student 126 may earn while playing in the metaverse via the experience platform 106, and may provide analytics for the student 126 including factors like student engagement 170, currency flow, overall system 100 usage, student retention, achievements, challenges, and other custom reports. The rewards API 148 may receive or send information on achievement history, recent achievements, badge information, and may also receive and send information about leaderboards, including ranking, creating leaderboards, and obtaining information on individual leaderboards, class leaderboards, and school leaderboards. The rewards API 148 may be adapted to receive and send information on points and digital currency 152 rules, daily limits, streak rules, and other information relating to the in-game mechanics of earning digital currency 152. The rewards API 148 may send and receive information relating to in-game challenges, such as which challenges may be generated, completed, or abandoned, and may also receive or send information relating to the digital currency 152 of each gaming environment 144, the rewards that each student 126 earns for digital currency 152, and whether the student 126 redeems the rewards for digital currency 152. Achievement and awards history, digital currency 152 inventory and redemptions, and other private transactions 162 may be saved on the blockchain 160 for added security. The rewards API 148 may be adapted to track information relating to parental controls 194 over digital currency 152, such as when the parent 164 sets an allowance or other restrictions, and may also track the progression of each student 126, including leveling and skills updates.

The rewards module 118 may be adapted to display to the student 126 via a rewards and incentives menu on the dashboard 128 the reward history, gifts that the student 126 may redeem, gift cards to the respective games of the platform in the form of digital currency 152, and student feedback. The rewards module 118 may update a leadership menu on the dashboard 128 to display gamification elements of the system 100, including weekly rewards, badges, achievements, and notifications, wherein the leadership menu may display individual leaderboards, class leaderboards, or school leaderboards based on data received from the rewards module 118. The rewards module 118 may be adapted to process redemption requests when the student 126 has accumulated enough experience points or in-app currency derived from experience points to redeem for a reward, wherein the parent 164 account may be linked for approval if the student 126 attempts to redeem rewards. The student 126 may select a reward and initiate the redemption, and the system 100 may then ask for parent 164 approval before finalizing the redemption by sending a notification to the linked parent 164 account. The parent 164 may review the request details including what the reward comprises and either approve or deny the request via the education platform 108. Upon parent 164 approval, the system 100 may proceed with the redemption to grant the reward to the student 126, successfully converting earned experience points into a virtual reward, with the transaction 162 authorized by the parent 164 and recorded on the blockchain 160 to maintain a verifiable audit trail of all reward distribution activities.

The security module 120 may be adapted to execute a transaction 162 on a blockchain 160 and provide the transaction 162 to a user, wherein the user may include the student 126, parent 164, teacher 166, or administrator 168. The security module 120 may be adapted to validate the game-instance 142 and the placement content 140 based on an age of the student 126. The blockchain 160 may be employed for credentialing purposes within the system 100, ensuring that achievements and competencies acquired by students 126 in the gaming environment 144 may be securely recorded and verifiable. The system 100 may employ a local registrar or outside registrar for the blockchain 160 to retain convenient access and provide precautions against unauthorized access. The blockchain 160 entries may be accessed by teachers 166, students 126, and parents 164 to review completed modules and earned credentials, promoting transparency and trust in the virtual learning accomplishments. The blockchain 160 may maintain immutable records of learning achievements that may be verified by authorized parties including the student 126, parent 164, teacher 166, and administrator 168. The use of blockchain 160 transactions 162 may ensure that students 126 utilizing the system 100, who may be legal minors, may be afforded privacy protections.

The blockchain 160 may employ cryptography standards and protocols set by organizations such as Enterprise Ethereum Alliance, the World Wide Web Consortium, the International Organization for Standardization, and the Institute of Electrical and Electronics Engineers. The blockchain 160 may include post-quantum cryptography to ensure the safety and security of personally identifiable information of the student 126 and parent 164. Achievement and awards history, digital currency 152 inventory and redemptions, and other private transactions 162 may be saved on the blockchain 160 for added security. The system 100 may utilize fraud detection to protect student 126 and parent 164 accounts, helping to reduce unauthorized transactions of digital currency 152 purchase or redemption. The AI agent 112 may detect content that might be problematic, inappropriate, or illegal, deferring the final decision to an administrator 168 via the education platform 108 to maintain platform standards and legal compliance. The system 100 may receive new content submissions and automatically trigger a content scan via the AI agent 112 for compliance checks, and the AI agent 112 may analyze the content for any violations or issues.

As shown in FIGS. 1A-1D, the database 122 may include a local database, shown as the database 122 option 1 in FIGS. 1C-1D; saved on a remote server and accessed via a network, shown as the database 122 option 2 in FIGS. 1C-D, such as a cloud server; or a combination of a local and a remote database 122, as required by the system 100. The database 122 may also include, for example, a vector database 122 or vector store for storing vectors, initialization vectors (IVs), feature vectors, or vector embeddings, e.g. flexible, meaning-based, probabilistic numerical representations of data that capture semantic meaning, allowing the system 100 to compare similarities between different types of data. The database 122 may also include a relational database 122, for example, data saved in a structured form, e.g. a structured query language (SQL) table, a comma-separated values (CSV) file, or in JavaScript object notation (JSON), or a JSON-related object or map, or object storage, or other forms of tabular input. The database 122 may also include a general storage database 122 to store, for example, unstructured data such as HTML, text, raw transcripts, chat logs, images, audio files, or social media posts. The database 122 may save documents and sensitive data, for example, on the blockchain for immutable document history, and integrate with smart contract platforms for automated transactional events. It should be understood that the database 122 may employ separate or secondary encryptions as needed to protect sensitive information, ensuring that the stored data remains secure and confidential when later retrieved by the user.

The system 100 may include a non-transitory computer-readable medium 200 operable to store processor instructions 202 for implementing curriculum-based educational activities for a student 126 within an interactive gaming environment 144. When the processor instructions 202 are executed by a processor 102, the processor instructions 202 may cause the processor 102 to receive, via a management module 116, educational data 124 and provide the educational data 124 to an education platform 108. The processor instructions 202 may cause the processor 102 to provide, via the education platform 108, the educational data 124 to the student 126 via a dashboard 128 and provide the educational data 124 to an analytics module 110. The processor instructions 202 may cause the processor 102 to correlate, via the analytics module 110, the educational data 124 to a placement 130, the placement 130 including a mastery level 132, a learning gap 134, or a readiness level 136 for advanced content 138. The processor instructions 202 may cause the processor 102 to generate, via an artificial intelligence (AI) agent 112, the placement content 140 from the placement 130 for incorporation in a game-instance 142. The processor instructions 202 may cause the processor 102 to generate, via a content generation module 114, the game-instance 142 within an experience platform 106 based on the placement content 140 via the AI agent 112. The processor instructions 202 may cause the processor 102 to generate, via the experience platform 106, an experience 146 within the interactive gaming environment 144, wherein the experience 146 may include the game-instance 142 and the placement content 140.

As shown in FIGS. 4A-4B, a method 300 for delivering curriculum-based educational activities for a student 126 within an interactive gaming environment 144 may be provided. The method 300 may include a step 302 of providing the system 100 for implementing curriculum-based educational activities for a student 126 within an interactive gaming environment 144 described herein above. The method 300 may include a step 304 of receiving, via a management module 116, educational data 124 and providing the educational data 124 to an education platform 108. The method 300 may include a step 306 of providing, via the education platform 108, the educational data 124 to the student 126 via a dashboard 128 and providing the educational data 124 to an analytics module 110. The method 300 may include a step 308 of correlating, via the analytics module 110, the educational data 124 to a placement 130, the placement 130 including a mastery level 132, a learning gap 134, or a readiness level 136 for advanced content 138. The method 300 may include a step 310 of generating, via an artificial intelligence (AI) agent 112, placement content 140 from the placement 130 for incorporation in a game-instance 142. The method 300 may include a step 312 of generating, via a content generation module 114, the game-instance 142 within an experience platform 106 based on the placement content 140 via the AI agent 112. The method 300 may include a step 314 of generating, via the experience platform 106, an experience 146 within the interactive gaming environment 144, wherein the experience 146 may include the game-instance 142 and the placement content 140.

As shown in FIG. 5, a method 400 for delivering curriculum-based educational activities for a student 126 within an interactive gaming environment 144 may be provided. The method 400 may include steps 302-314 of method 300 (as steps 402-414 respectively). The method 400 may include a step 416 of interfacing, via the management module 116, with a learning management system 188 through a course API 190 to receive the educational data 124, wherein the educational data 124 may include an academic signal 172, an assignment 174, a grade 192, or progress 176 data. The method 400 may include a step 418 of interfacing, via the management module 116, with the learning management system 188 provided by an educational institution 186. The method 400 may include a step 420 of tracking, via the management module 116, the performance 154 of the student 126, wherein the performance 154 may be accessible by the student 126, the parent 164, the teacher 166, or the administrator 168. The method 400 may include a step 422 of generating, via the AI agent 112, the feedback 178 based on the placement 130, wherein the feedback 178 may include a personalized tutoring session 180, an explanation 182, or a guided practice sequence 184. The method 400 may include a step 424 of generating and syncing, via the experience platform 106, the experience 146 across a plurality of interactive gaming environments 144.

As shown in FIG. 6, a method 500 for delivering curriculum-based educational activities for a student 126 within an interactive gaming environment 144 with blockchain-verified rewards may be provided. The method 500 may include steps 302-314 of method 300 (as steps 502-514 respectively). The method 500 may include a step 516 of tracking a learning achievement and a digital incentive 158 via a blockchain 160 transaction 162 through a rewards module 118. The method 500 may include a step 518 of distributing the digital incentive 158 based on the performance 154 of the student 126 within the game-instance 142. The method 500 may include a step 520 of interfacing, via the rewards module 118, with a rewards API 148 to receive incentive data 150, wherein the incentive data 150 may include a student engagement 170, a digital currency 152, an achievement history, a leaderboard, a challenge prompt, or a parental control 194. The method 500 may include a step 522 of executing a transaction 162 on a blockchain 160 via a security module 120. The method 500 may include a step 524 of providing the transaction 162 to a user, wherein the user may include the student 126, a parent 164, a teacher 166, or an administrator 168.

The present technology may advantageously address challenges faced by educational platforms through immersive learning experiences that may be delivered within gaming environments familiar to students, thereby enhancing engagement beyond what static content delivery methods may offer. Adaptive learning pathways driven by artificial intelligence may be personalized to individual learner needs, skill levels, and pace, moving beyond one-size-fits-all approaches and grade-level constraints that may limit student advancement. Curriculum-aligned educational content may be seamlessly integrated with popular gaming platforms and metaverse ecosystems, eliminating the separation between educational tools and gaming environments that may result in lower student engagement. Real-time analytics and progress tracking may be made accessible to students, parents, and educators, addressing challenges related to assessment mechanisms and disconnected data systems. Digital incentives and rewards based on academic performance may be provided to increase motivation while translating learning achievements into recognized educational metrics that may be incorporated into institutional evaluation systems. Unified architecture may be established to operate across school-managed learning management system environments and direct-to-consumer platforms, enabling both institutionally-enrolled students and independent learners to benefit from orchestration, mastery tracking, and tutoring resources that may otherwise be inaccessible.

### EXAMPLES

Example embodiments of the present technology are provided with reference to the several figures including FIGS. 1-6 enclosed herewith.

### Example One: Course Enrollment and Learning Progress

The student 126 may be logged into the system 100 and there may be available courses visible. The student 126 may meet any prerequisites for enrolling, if applicable, and may browse the list of available courses in the system 100 catalog. The student 126 may select the desired course and may submit an enrollment request for that course. The system 100 may record the enrollment request and may send a notification to the teacher 166 that a new student 126 wants to enroll. When the student 126 may request enrollment in a course that the teacher 166 teaches, the request may be pending approval in the system 100. The teacher 166 may log into the system 100 and may navigate the pending enrollment requests or may check notifications.

The teacher 166 may find a request from a student 126 to join the course and may open the request details. The teacher 166 may review the information from the student 126 and may ensure the student 126 may be eligible or appropriate for the course. The teacher 166 may click "Approve" or "Reject" for the enrollment request. In this main flow, the teacher 166 may approve the student 126 and the system 100 may process the approval, adding the student 126 to the course active enrollment list and notifying the student 126 that the enrollment was approved, and the student 126 now may have access to the course content. The student 126 may now access the course lessons and materials, and the class roster may be updated to include the new student 126. This may ensure a teacher 166 may have control over who joins the courses when approval may be required.

The student 126 may then navigate to the course page on the education platform 108 where all course lessons and modules may be listed and may select a lesson. The system 100 may retrieve the content of the selected lesson, which could include text, videos, quizzes, etc., and may display it to the student 126. The student 126 may engage in the lesson content, reading materials and completing any embedded questions or exercises. As the student 126 may progress or may complete the lesson, the system 100 may update the student 126 progress 176 for that course, for example, marking the lesson as completed, updating a progress percentage, or unlocking the next module. The student 126 may view the progress 176 in the course, such as which lessons may be done and what the current completion status may be, on the course or progress page. The system 100 may track the completion of the lesson and may update the student 126 learning progress 176. This may ensure the student 126, and the teacher 166 or parent 164, may later review which content has been completed and how far along the student 126 may be in the course.

### Example Two: User Registration and Authentication

A student 126 may navigate to the registration page and may choose to create a new account, entering details such as name, email, and password and submitting the registration form. The system 100 may create a new account for the student 126 and may store the student 126 credentials securely. If email verification may be required, the system 100 may send a verification email, and the student 126 may verify an email address. The system 100 may confirm the successful account creation to the student 126, e.g., via a welcome message or redirect to a login page.

Similarly, a teacher 166 may be new to the platform with no account. An administrator 168 role may exist to approve new teacher 166 accounts. The new teacher 166 may initiate the account registration process by providing the required information such as profile details, credentials, and possibly verification documents. The system 100 may accept the registration submission and may mark the teacher 166 account as "pending approval." The system 100 may notify an administrator 168 that a new teacher 166 account may be awaiting review. The administrator 168 may review the information from the teacher 166 to verify the identity or credentials of the teacher 166. The administrator 168 may approve the registration for the teacher 166 and system 100 may activate the teacher 166 account and may notify the teacher 166, for example, via email, that the account may be approved and ready to use. The teacher 166 and student 126 may log in to accounts with a multi-factor authentication enabled via the user authentication and onboarding menu, e.g., they may have a registered email or device for receiving one-time codes.

### Example Three: AI-Generated Roblox ® Experience

A student 126 may be logged in and may have access to an AI-driven Roblox^{®} experience 146 (for example, the course may include a Roblox^{®}-based educational game via the experience platform 106). The Roblox^{®} integration and AI generation service may be available via the content generation module 114 and the AI agent 112. The student 126 may start a Roblox^{®}-based learning activity from the application, e.g., clicks "Play Learning Game" in the course content. The system 100 may receive the request and may signal the AI agent 112 that the student 126 wants to launch the interactive learning environment 144. The AI agent 112 may gather the learning profile and current progress 176 of the student 126, e.g., current topic, difficulty level, past performance 154, to tailor the experience 146. The AI agent 112 may communicate with the Roblox^{®} experience platform 106 to generate a custom learning world. It may pass along parameters like the subject matter or difficulty tuning based on the student 126 data. The Roblox^{®} experience 146 may create a new instance of a virtual world or game-instance 142 that may incorporate educational challenges aligned with the needs of the student 126, for example, a math puzzle adventure or a historical simulation game.

Once the custom environment may be ready, the system 100 may connect the student 126 to that Roblox^{®} game-instance 142, redirecting the student 126 to Roblox^{®} or loading the game-instance 142 within the app. The student 126 may be transported into a personalized Roblox^{®} game-instance 142 designed for educational level and needs. From the perspective of the student 126, the student 126 may seamlessly launch an interactive learning game-instance 142 that may be customized for them, enhancing engagement 170. The AI agent 112 may have the capability to define game-instance 142 parameters and the Roblox^{®} platform may create dynamic content, including educational objectives for the session, for example, practice algebra equations, explore a historical scene, etc. based on the current curriculum or needs of the student 126, type of world, difficulty of tasks, and specific learning content to include, e.g., "generate a treasure hunt with math problems about fractions". The AI agent 112 may send a request to the Roblox^{®} experience platform 106 service or API with these parameters to create the game-instance 142. The Roblox^{®} experience platform 106 service may process the request and programmatically may build a new game session. This may include setting up the environment graphics, embedding the educational challenges or quizzes, and adjusting game mechanics to the desired difficulty. The Roblox^{®} experience platform 106 may ready the custom world by dynamically creating the educational gameplay experience 146 and may send a confirmation back to the system 100 that the game-instance 142 may be live. The system 100 may notify the education platform 108 that the personalized game-instance 142 may be available and may initiate the connection for the student 126 to join that specific game world.

The AI agent 112 may monitor the session or may receive data about the student 126 performance 154 in real time. For example, the Roblox^{®} experience platform 106 may track the student 126 performance 154 data during gameplay, e.g. which questions the student 126 gets right or wrong, how quickly the student 126 solves puzzles, where the student 126 might be failing or succeeding easily. The AI agent 112 may receive periodic updates or may have access to this performance 154 data from the Roblox^{®} experience platform 106 and may assess if the current difficulty level may be appropriate. For instance, if the student 126 may be answering all questions correctly very quickly, the AI agent 112 may infer the level may be too easy; if the student 126 may be struggling or failing repeatedly, the AI agent 112 may infer it might be too hard. Based on this analysis, the AI agent 112 may send instructions to the Roblox^{®} experience platform 106 to adjust the game-instance 142 difficulty or content in real-time. This could include making the next set of questions harder or easier, providing hints or tips, or altering the game-instance 142 environment to better suit the pace of the student 126. The Roblox^{®} experience platform 106 may implement these changes immediately. As the student 126 may continue playing, the student 126 may encounter a modified difficulty, for example, more challenging puzzles if the student 126 were breezing through, or added guidance if the student 126 were stuck. The student 126 may remain engaged – not bored by tasks that may be too easy and not discouraged by tasks that may be too difficult – leading to a more effective and personalized learning experience.

### Example Four: AI-Driven Adaptive Learning

A student 126 may be enrolled in a course and there may be an available quiz or assessment. The teacher 166 may be assigned to the course and able to grade 192 submissions if manual grading may be required. The student 126 may submit an online quiz or assessment provided within the course and may answer all questions. The system 100 may notify the teacher 166 that the student 126 has completed the assessment, for assessments requiring teacher 166 grading 192 or review. The teacher 166 may review the answers, allowing the system 100 to auto-grade simple tests like multiple choice, while the teacher 166 might grade 192 open-ended responses and add comments. The teacher 166 may enter the grade 192 and any feedback 178 for the student 126 assessment into the system 100 and the system 100 may update the records. The student 126 may receive the results and may gain knowledge of how well the student 126 performed and what mistakes were made. The grading 192 and feedback 178 from the teacher 166 may be communicated back to the student 126 through the system 100, closing the loop on the assessment.

The system 100 may also compile the performance 154 data, e.g., quiz scores, types of problems missed, time taken on various tasks, and may send the data to the AI agent 112 for analysis. The AI agent 112 may formulate a recommendation for what the student 126 should study or do next. This could be a suggestion for remedial content on topics where the student 126 struggled, or more advanced content 138 if the student 126 may be excelling. The AI agent 112 may send the recommended next learning steps or personalized content back to the system 100. The system 100 may prepare to deliver this recommendation to the student 126, e.g., as a suggested activity or highlighted content when the student 126 next logs in. The recommendation may be presented to the student 126, aiming to improve learning outcomes by addressing individual needs.

The student 126 may navigate to the course or the next lesson on the education platform 108 after completing an assessment. The system 100 may present a personalized recommendation or learning path update to the student 126. For example, a message might be displayed: "Based on your quiz results, you should review Chapter 4 before moving on," along with a direct link to Chapter 4 materials. The student 126 may follow the recommendation by clicking the suggested content or activity. By following the suggestion by the AI agent 112, the student 126 may improve on weak areas or continue to be challenged, making the learning experience more effective.

### Example Five: Compliance & Content Moderation

A teacher 166 may be logged in and may be authorized to add content to a course, meaning the account may be active and the teacher 166 may be the ‘instructor’ for the course. The content moderation through the AI agent 112 may be running and up-to-date with compliance rules, e.g., filters for inappropriate content, copyright, COPPA guidelines, etc. The teacher 166 may navigate to the course management area and may select an option to upload or create new course content, such as a new lesson, video, or resource, and may upload files and media for the course. The system 100 may receive the new content submission and may automatically trigger a content scan via the AI agent 112 for compliance checks, which may happen in the background upon submission. The AI agent 112 may analyze the content for any violations or issues. In this scenario, assume the content fully meets all guidelines relating to rules such as no offensive material, all student 126 data privacy standards upheld, etc. If no problems may be detected, the system 100 either may automatically approve the content or, if minimal oversight may be still required, may flag it as safe for quick administrator 168 review. The content may be immediately made available in the course for students 126 or become available after a rapid auto-approval process. The system 100 may confirm back to the teacher 166 that the content has been uploaded successfully and may be now live for student 126 access. This process may ensure that even routine content additions go through an automated safety net via the AI agent 112 scan, maintaining quality and compliance silently.

If a teacher 166 may upload inappropriate or non-compliant elements, however, the system 100 may flag the content, and an administrator 168 may manually review flagged content. The AI agent 112 may detect a potential compliance issue in the content. For example, the content might contain a prohibited phrase or personal student 126 data which violates privacy guidelines, or perhaps copyrighted material that may not be allowed. The system 100 may alert an administrator 168, or moderator, that there may be content awaiting review due to a compliance flag. This could be via an administrator 168 account notification or an email alert saying, "Content X requires approval." Until an administrator 168 reviews it, the content may remain inaccessible to students 126, meaning not published in the course. The system 100 may display the content to the administrator 168 along with any notes on why it was flagged, e.g., "Flagged for language" or "Potential privacy issue detected". Based on the review, the administrator 168 may decide to reject the content if it indeed violates a guideline, for example, it contains a disallowed piece of student 126 personal information or off-topic material.

### Example Six: Gamification & Rewards

A student 126 may be participating in learning activities such as lessons, quizzes, etc. while logged into the account. Gamification including point system and achievements may be enabled in the platform. The student 126 may complete a learning task, for example, finishes a lesson module or achieves a high score on a quiz. The system 100 may award a certain number of experience points to the student 126 based on the completion of the task and the performance 154 of the student 126, e.g., 50 experience points for completing the lesson, plus bonus experience points for a perfect quiz score. If the completed task may meet a criterion for an achievement, for instance, "Completed 5 lessons" or "Perfect score on first attempt", system 100 may unlock that achievement badge or trophy for the student 126 profile. The system 100 may update and may send the updated experience points and any achievement info to the rewards API 148 and may recalculate the rankings with the new experience points totals. The dashboard 128 on the education platform 108 may refresh to show the new experience points total, and any new badge earned. The student 126 may also view the leaderboard to see the updated rank among peers. This positive feedback loop may encourage the student 126 to continue engaging with the learning material to gain more points and achievements. The visibility of competitive standing may also motivate the student 126 to earn more experience points and achievements, adding a social element to the learning experience through friendly competition.

Once the student 126 has accumulated enough experience points, or an in-app currency derived from experience points, to redeem for a reward. A parent 164 account may be linked for approval if the student 126 may be a minor. The rewards catalog, e.g., virtual items in Roblox^{®} or other perks may be available. The student 126 may select a reward, for example, a "Roblox^{®} virtual backpack" that costs 500 experience points, and may initiate the redemption. The system 100 may then ask for parent 164 approval before finalizing the redemption, e.g., the system 100 may send a notification to the linked parent 164 account saying, "student 126 A wants to redeem 500experience points for a Roblox^{®} backpack". The parent 164 may review the request details, for example, what the reward comprises and how many points will be spent, and either approve or deny the request. Upon parent 164 approval, the system 100 may proceed with the redemption through a payment system or directly with the Roblox^{®} experience platform 106 to grant the virtual reward to the student 126, successfully converting earned experience points into a virtual reward, with the transaction 162 authorized by a parent 164. The student 126 may gain the chosen reward, enhancing engagement 170 in the Roblox^{®} experience 146 or platform, and the experience points total may be reduced accordingly.

### Example Seven: In-App Communication & Notifications

A student 126 may open the education platform 108 messaging or chat feature and may select the teacher 166, or the specific course chat room, to ask a question to the teacher 166. The teacher 166 may type a response with an explanation or answer to the student 126 inquiry and may send it. The teacher 166 may also post a new assignment or update in a course that the student 126 may be enrolled in OR an assignment deadline may be approaching. The notifications and alerts menu may alert a student 126 of such events. For a new assignment, it might be: "New assignment posted in Math-101: Algebra Project." For a reminder, it might be: "Reminder: Quiz 2due tomorrow in Science 201." The student 126 may promptly view the assignment details and timely start the assignment or be reminded to complete it, improving time management and reducing the chance of missing the task.

The parent 164 may be linked to a student 126 account and has opted to receive regular progress 176 reports, for example, at the end of the week. The system 100 may generate a weekly summary report of the progress 176 of the student 126, such as courses taken, lessons completed, quiz scores, time spent on the platform, and any new achievements earned during that week. This report might include highlights like "John completed 3 lessons this week and scored an average of 85% on quizzes. He earned 200 experience points and 1 new badge." It may also note areas for improvement if applicable. The system 100 may send out the weekly progress 176 report to designated channel for the parent 164, for example, an email to the email address of the parent 164 on file, or an in-app notification that a report may be ready to view. The parent 164 may receive the notification and may open the report. The parent 164 may review the progress 176 report of the student 126, seeing the accomplishments and progress 176 made, as well as any concerns or remarks included. The parent 164 may stay engaged with the learning path of the student 126 and may enable them to congratulate the child or address any issues, such as low performance 154 or low engagement 170 promptly, strengthening the communication loop between the system 100 and parents 164 regarding student 126 performance 154.

### Example Eight: Parent Monitoring & Learning Control

A parent 164 may log into the application using parent 164 credentials, where the system 100 may fetch the latest performance 154 and progress 176 data for the child. This may include the student 126 and the current courses, how many lessons may be completed in each, quiz or exam scores, current overall grades 192 or proficiency levels, and any recent achievements. The education platform 108 could show charts or summaries, such as a progress bar for each course, recent grades 192, and comparisons to set goals. Parent 164 may review the information on the education platform 108, gaining insight into areas where the student 126 may be doing well and areas that might need attention, for example, the parent 164 might notice the child may be 50% through a course or has a low score in a recent assignment. This transparency may allow the parent 164 to engage with the student 126 about the studies or reach out to teachers 166 if necessary.

The parent 164 may also set parental controls 194, including establishing a learning goal for the student 126. For example, the parent 164 may set a goal like "Complete at least 4 lessons this week" or "Read for 30 minutes daily." The parent 164 may enter these goals into the system 100 or setting screen time limits or schedule restrictions for the experience platform 106 usage. For instance, the parent 164 may specify allowed usage hours, e.g., only between 7am-9pm, or a maximum daily usage duration, e.g., 2 hours per day on weekdays. The parent 164 may also restrict certain features of the experience platform 106 to specific times. The system 100 will track progress 176 toward the goals and monitor usage time against the limits. If the parent 164 limits screen time, the system 100 may deny the student 126 access to the learning application when the allowed time has been exceeded or during a restricted hour. For example, the student 126 has been playing in the metaverse through the experience platform 106 for more than 2 hours, or it may be past 9pm which may be the set curfew. For example, the system 100 may send a pop-up message saying, "Your usage time for today has been reached" or "Access not allowed at this time per parental settings." The system 100 may also send a notification to the parent 164 that the screen time limit was reached or that an attempt was made outside allowed hours, so the parent 164 may be aware of the enforcement, adding a layer of security and control over the learning environment of the student 126.

### Example Nine: Performance Analytics & Reports

A teacher 166 may gather data on a student 126, including a student 126 report for quiz scores, assignment grades 192, lesson completion status, time spent on tasks, and any other engagement 170 metrics to date. The system 100, with the help of the AI agent 112 for deeper analysis, may compile the data into an organized report. The report might highlight information like average score, improvement over time, topics mastered versus topics needing improvement, comparison to class average, etc. If AI agent 112 analysis may be used, the report could include insights such as "The student 126 performs better in visual exercises than text-based exercises" or "Scores have improved after each attempt, indicating a good learning curve." The teacher 166 may review the report to understand the progress 176 of the student 126 and may identify any areas where intervention might be needed such as re-teaching a concept or providing extra challenges.

The system 100 may also allow an administrator 168 global analytics via the analytics module 110, aimed at an administrator 168 overview covering all courses, student 126 engagement 170, and activities on the system 100. The global analytics may include the total number of active students 126 and teachers 166, number of courses offered, overall course completion rates, average student 126 performance 154 metrics, peak usage times, and other performance indicators of the platform. The AI agent 112 may highlight notable trends or anomalies, e.g., "There may be a drop in engagement 170 on weekends" or "students 126 in language courses show 20% higher completion rates than those in math courses". An administrator 168 may use these analytics to assess the overall health of the education platform 108 and to make decisions. For example, if analytics show low engagement 170 in a certain type of course, the administrator 168 might plan to investigate or provide additional support for those courses. A teacher 166 might see insights specific to the class, whereas an administrator 168 might see broader insights. A teacher 166 might implement the suggestion by altering the teaching approach or providing extra material. An administrator 168 might use the information to guide policy or platform feature decisions, such as encouraging all courses to include more interactive content.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods may be made within the scope of the present technology, with substantially similar results.

What is claimed is:

1. A system for implementing curriculum-based educational activities for a student within an interactive gaming environment, comprising:
a processor; and
a memory in communication with the processor, the memory including a management module, an education platform module, an experience platform module, an analytics module, an artificial intelligence (AI) agent, a content generation module;
wherein:
the management module is configured to receive educational data and provide the educational data to the education platform;
the education platform is configured to provide the educational data to the student via a dashboard and provide the educational data to the analytics module;
the analytics module is configured to correlate the educational data to a placement selected from a group consisting of a mastery level, a learning gap, a readiness level for advanced content, and combinations thereof;
the AI agent is configured to generate placement content from the placement for incorporation in a game-instance via the content generation module;
the content generation module is configured to generate the game-instance within the experience platform based on the placement content via the AI agent; and
the experience platform is configured to generate the experience within the interactive gaming environment,
wherein the experience includes the game-instance and the placement content.

2. The system of claim 1, wherein the management module is further configured to interface with a learning management system (LMS) through a course application programming interface (course API) to receive the educational data, the educational data including a member selected from a group consisting of an academic signal, an assignment, a grade, a progress data, and combinations thereof.

3. The system of claim 2, wherein the management module interfaces with the LMS is provided by an educational institution.

4. The system of claim 1, wherein the management module is further configured to track a performance of the student, the performance accessible by a member selected from a group consisting of a student, a patent, a teacher, an administrator, and combinations thereof.

5. The system of claim 1, wherein the AI agent is further configured to generate a feedback based on the placement, the feedback including a member selected from a group consisting of a personalized tutoring session, an explanation, a guided practice sequence, and combinations thereof.

6. The system of claim 1, wherein the experience platform is further configured to generate and sync an experience across a plurality of interactive gaming environments.

7. The system of claim 1, wherein the memory further includes a rewards module, the rewards module including a blockchain transaction for tracking a learning achievement and a digital incentive, the rewards module configured to distribute the digital incentive based on a performance of the student within the game-instance.

8. The system of claim 7, wherein the rewards module is further configured to interface with a rewards application programming interface (rewards API) to receive incentive data, the incentive data including a member selected from a group consisting of a student engagement, a digital currency, an achievement history, a leaderboard, a challenge prompt, a parental control setting, and combinations thereof.

9. The system of claim 1, wherein the memory further includes a security module, the security module configured to execute a transaction on a blockchain, the security module further configured to provide the transaction to a user, the user including a member selected from a group consisting of a student, a parent, a teacher, an administrator, and combinations thereof.

10. The system of claim 9, wherein the security module is further configured to validate the game-instance and the placement content based on an age of the student.

11. A method for delivering curriculum-based educational activities for a student within an interactive gaming environment, comprising:
providing a processor, and a memory in communication with the processor, the memory including a management module, an education platform module, an experience platform module, an analytics module, an artificial intelligence (AI) agent, a content generation module; wherein: the management module is configured to receive educational data and provide the educational data to the education platform; the education platform is configured to provide the educational data to the student via a dashboard and provide the educational data to the analytics module; the analytics module is configured to correlate the educational data to a placement selected from a group consisting of a mastery level, a learning gap, a readiness level for advanced content, and combinations thereof; the AI agent is configured to generate placement content from the placement for incorporation in a game-instance via the content generation module; the content generation module is configured to generate the game-instance within the experience platform based on the placement content via the AI agent; and the experience platform is configured to generate the experience within the interactive gaming environment, wherein the experience includes the game-instance and the placement content;
receiving, via the management module, the educational data and providing the educational data to the education platform;
providing, via the education platform, the educational data to the student via the dashboard and providing the educational data to the analytics module;
correlating, via the analytics module, the educational data to the placement;
generating, via the AI agent, the placement content from the placement for incorporation in the game-instance;
generating, via the content generation module, the game-instance within the experience platform based on the placement content; and
generating, via the experience platform, the experience within the interactive gaming environment, wherein the experience includes the game-instance and the placement content.

12. The method of claim 11, further comprising interfacing with a learning management system (LMS) via the management module through a course application programming interface (course API) to receive the educational data, the educational data including an academic signal, an assignment, a grade, or a progress data.

13. The method of claim 12, further comprising interfacing with the LMS provided by an educational institution via the management module.

14. The method of claim 11, wherein:
the management module is further configured to track a performance of the student, the performance accessible by a member selected from a group consisting of a student, a patent, a teacher, an administrator, and combinations thereof; and
the method further comprising:
tracking the performance of the student.

15. The method of claim 11, wherein:
the AI agent is further configured to generate a feedback based on the placement, the feedback including a member selected from a group consisting of a personalized tutoring session, an explanation, a guided practice sequence, and combinations thereof; and
the method further comprising:
generating the feedback based on the placement.

16. The method of claim 11, wherein:
the experience platform is further configured to generate and sync an experience across a plurality of interactive gaming environments; and
the method further comprising:
generating and syncing the experience across the plurality of interactive gaming environments.

17. The method of claim 11, wherein:
the memory further includes a rewards module, the rewards module including a blockchain transaction for tracking a learning achievement and a digital incentive, the rewards module configured to distribute the digital incentive based on a performance of the student within the game-instance; and
the method further comprising:
tracking the learning achievement and the digital incentive via the blockchain transaction; and
distributing the digital incentive based on the performance of the student within the game-instance.

18. The method of claim 17, wherein:
the rewards module is further configured to interface with a rewards application programming interface (rewards API) to receive incentive data, the incentive data including a member selected from a group consisting of a student engagement, a digital currency, an achievement history, a leaderboard, a challenge prompt, a parental control setting, and combinations thereof; and
the method further comprising:
interfacing with the rewards API to receive the incentive data.

19. The method of claim 11, wherein:
the memory further includes a security module, the security module configured to execute a transaction on a blockchain, the security module further configured to provide the transaction to a user, the user including a member selected from a group consisting of a student, a parent, a teacher, an administrator, and combinations thereof; and
the method further comprising:
executing the transaction on the blockchain; and
providing the transaction to the user.

20. A non-transitory computer-readable medium storing instructions for implementing curriculum-based educational activities for a student within an interactive gaming environment that, when executed by a processor, cause the processor to:
receive, via a management module, educational data and provide the educational data to an education platform;
provide, via the education platform, the educational data to the student via a dashboard and provide the educational data to an analytics module;
correlate, via the analytics module, the educational data to a placement, the placement including a member selected from a group consisting of a mastery level, a learning gap, or a readiness level for advanced content;
generate, via an artificial intelligence (AI) agent, a placement content from the placement for incorporation in a game-instance;
generate, via a content generation module, the game-instance within an experience platform based on the placement content via the AI agent; and
generate, via the experience platform, an experience within the interactive gaming environment, wherein the experience includes the game-instance and the placement content.
